(19) United States
(12) Patent Application Publication
(10) Pub. No.: US 2016/0264070 A1
(43) Pub. Date: Sep. 15, 2016

(54) VEHICLE OPERATION SYSTEM

(71) Applicant: YAZAKI CORPORATION, Tokyo (JP)

(72) Inventors: Shuhei Urakami, Shizuoka (JP); Takafumi Saito, Shizuoka (JP)

(21) Appl. No.: 15/064,182

(22) Filed: Mar. 8, 2016

(30) Foreign Application Priority Data
Mar. 13, 2015 (JP) 2015-050978
Mar. 13, 2015 (JP) 2015-050982

(51) Int. Cl. B60R 16/00; G05G 1/04

(52) U.S. Cl. CPC B60R 16/005; G05G 1/04

(57) ABSTRACT

A vehicle operation system includes: a longitudinal member projected and extended from a steering column; an action detecting unit that is arranged at a distal end in a projecting direction of the longitudinal member, and detects an operation form of an operator in operating an onboard device at the distal end or in a sensing space with the distal end being a base point; and a controller that transmits a command to the onboard device based on an output signal from the action detecting unit in accordance with the operation form of the operator. The action detecting unit sets an operation direction along natural movement of a finger of the operator gripping a steering wheel, and allocates a function of the onboard device to the operation direction.

### CROSS-REFERENCE TO RELATED APPLICATION(S)

The present application claims priority to and incorporates by reference the entire contents of Japanese Patent Application No. 2015-050978 filed in Japan on Mar. 13, 2015 and Japanese Patent Application No. 2015-050982 filed in Japan on Mar. 13, 2015.

### BACKGROUND OF THE INVENTION

1. Field of the Invention

The present invention relates to a vehicle operation system.

2. Description of the Related Art

A vehicle operation system is used by an operator to operate an onboard device mounted on a vehicle. For example, as the vehicle operation system, known is a system including a lever operation unit arranged on a steering column and a detecting unit for detecting movement of a hand or a finger arranged on a distal end of the lever operation unit, which enables the operator to operate the onboard device without removing his/her hand from a steering wheel (for example, refer to Japanese Patent Application Laid-open No. 2014-144693). According to the technique disclosed in Japanese Patent Application Laid-open No. 2014-144693, the detecting unit is arranged on the distal end of the lever operation unit.

Known operation forms with respect to an operation part at the distal end of the lever operation unit include a touch operation of touching the operation part with a finger, a depressing operation of depressing the operation part with a finger, a slide operation of sliding a finger on the operation part or sliding the operation part with a finger, and the like. In addition to such a contact operation with respect to the operation part, also known is a non-contact operation form of detecting movement of a finger in a space of a predetermined range with the operation part being a base point. As the non-contact operation form, considered are a gesture operation within a space of a predetermined range corresponding to the touch operation or the depressing operation, and a gesture operation within a space of a predetermined range corresponding to the slide operation. The touch operation or the depressing operation with respect to the distal end of the lever can be performed without putting a burden on a finger of the operator gripping a steering wheel. However, the slide operation with respect to the distal end of the lever puts a burden on a finger of the operator depending on a sliding direction when the slide operation is performed while the operator keeps gripping the steering wheel.

A direction in which a finger can be easily moved is different for each operator, so that a direction of finger action based on which the onboard device is operated is preferably settable for each operator. In this way, the vehicle operation system can be further improved in operability.

### SUMMARY OF THE INVENTION

It is an object of the present invention to provide a vehicle operation system that can reduce a burden on a finger of an operator.

Also, it is an object of the present invention to provide a vehicle operation system having improved operability.

In order to achieve the above mentioned object, a vehicle operation system according to one aspect of the present invention includes a longitudinal member that is projected and extended from a steering column; an action detecting unit that is arranged at a distal end in a projecting direction of the longitudinal member, and detects an operation form of an operator in operating an onboard device at the distal end or in a sensing space with the distal end being a base point; and a controller that transmits a command to the onboard device based on an output signal from the action detecting unit in accordance with the operation form of the operator, wherein the action detecting unit sets an operation direction along natural movement of a finger of the operator gripping a steering wheel, and allocates a function of the onboard device to the operation direction.

According to another aspect of the present invention, in the vehicle operation system, it is desirable that the operation direction along natural movement of the finger of the operator is a direction along a bending and stretching direction of the finger or a direction orthogonal to the direction along the bending and stretching direction.

According to still another aspect of the present invention, in the vehicle operation system, it is desirable that the action detecting unit includes a contact sensor capable of detecting an object being in contact with a contact operation region of the distal end and a moving direction of the object, or a non-contact sensor capable of detecting an object present in the sensing space and a moving direction of the object in the sensing space.

According to still another aspect of the present invention, in the vehicle operation system, it is desirable that at least one combination of the longitudinal member and the action detecting unit is arranged on at least one of a left end and a right end of the steering column in a vehicle width direction.

According to still another aspect of the present invention, it is desirable that the vehicle operation system further includes a main operation device including a lever operation unit that includes the longitudinal member and a lever operation detecting unit that detects an inclining direction of inclining action using an end of the longitudinal member on the steering column side as a fulcrum, and operating the onboard device allocated to the inclining direction of the inclining action as an operation direction of the longitudinal member or an onboard device different from the former onboard device, and an auxiliary operation device including the action detecting unit.

According to still another aspect of the present invention, in the vehicle operation system, it is desirable that at least one combination of the main operation device and the auxiliary operation device is arranged on at least one of the left end and the right end of the steering column in the vehicle width direction.

According to still another aspect of the present invention, in the vehicle operation system, it is desirable that the action detecting unit has a distal end surface at a distal end in an extending direction of the longitudinal member, detects an operation form allocated to a working form included in the onboard device on the distal end surface side or in a sensing space with the distal end surface being a base point, and is arranged so that an angle of at least the distal end surface is capable of being freely changed about an axis at the distal end of the longitudinal member, and the controller controls the onboard device based on the operation form detected by the action detecting unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a front view illustrating a configuration of a vehicle operation system according to a first embodiment and a first modification;

FIG. 2 is a top view illustrating a configuration of the vehicle operation system according to the first embodiment and the first modification;

FIG. 3 is a diagram for explaining an example of a slide operation;

FIG. 4 is a diagram for explaining an example of a touch operation;

FIG. 5 is a perspective view illustrating a configuration of an auxiliary operation device according to the first embodiment;

FIG. 6 is a perspective view illustrating another configuration example of the auxiliary operation device according to the first embodiment;

FIG. 7 is a diagram for explaining an example of display content of a display device;

FIG. 8 is a perspective view illustrating a configuration of an auxiliary operation device according to the first modification;

FIG. 9 is a front view illustrating a configuration of a vehicle operation system according to a second modification;

FIG. 10 is a diagram for explaining an example of a non-contact operation;

FIG. 11 is a schematic diagram illustrating a vehicle operation system according to a second embodiment;

FIG. 12 is a block diagram illustrating a schematic configuration of the vehicle operation system;

FIG. 13 is a schematic diagram illustrating a main operation device and the auxiliary operation device in the vehicle operation system;

FIG. 14 is a perspective view illustrating the main operation device and the auxiliary operation device in the vehicle operation system;

FIG. 15 is a perspective view illustrating the main operation device and the auxiliary operation device in the vehicle operation system;

FIG. 16 is a perspective view illustrating a main operation device and an auxiliary operation device in a vehicle operation system according to a third modification;

FIG. 17 is a perspective view illustrating the main operation device and the auxiliary operation device in the vehicle operation system;

FIG. 18 is a schematic diagram illustrating a vehicle operation system according to a fourth modification; and

FIG. 19 is a schematic diagram illustrating the main operation device and the auxiliary operation device in the vehicle operation system.

### DETAILED DESCRIPTION OF THE PREFERRED EMBODIMENTS

The following fully describes a vehicle operation system according to embodiments of the present invention with reference to the accompanying drawings. The embodiments are not intended to limit the scope of the present invention.

### First Embodiment

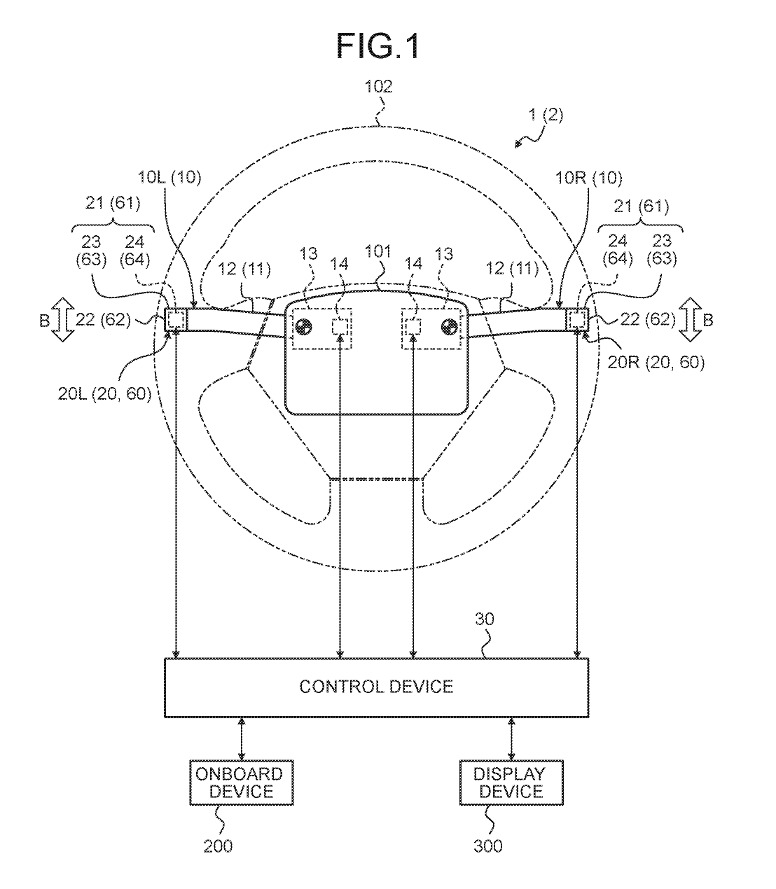

The vehicle operation system according to a first embodiment of the present invention will be described with reference to FIGS. 1 to 7.

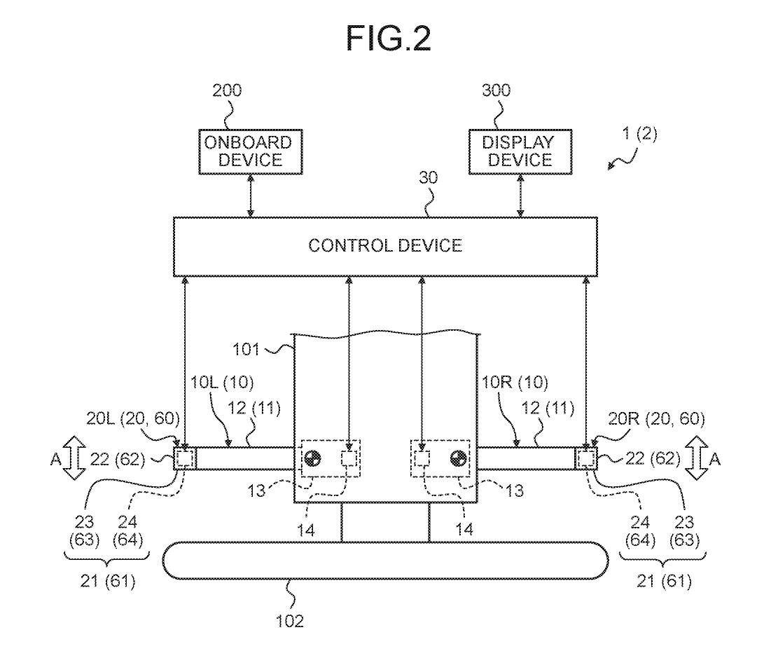

The vehicle operation system according to the first embodiment allows an operator (driver) to operate onboard devices installed in the vehicle without removing his/her hand from the steering wheel. The reference sign 1 in FIGS. 1 and 2 indicates the vehicle operation system described above.

The vehicle operation system 1 according to the first embodiment is provided to a steering column 101 inside the vehicle. Specifically, the vehicle operation system 1 is disposed at the back of a steering wheel 102, that is, disposed closer to the front side of the vehicle than the steering wheel 102 is disposed. The vehicle operation system 1 includes a main operation device 10 and an auxiliary operation device 20 for operating an onboard device 200, and a control device (controller) 30. The vehicle operation system 1 includes at least one combination of the main operation device 10 and the auxiliary operation device 20 arranged on at least one of the left side and the right side in a vehicle width direction of the steering column 101. In FIG. 1, for example, one combination of a main operation device 10L and an auxiliary operation device 20L is arranged on the left side of the steering column 101, and one combination of a main operation device 10R and an auxiliary operation device 20R is arranged on the right side of the steering column 101.

The onboard device 200 has at least one function (working form) operative in accordance with the operation on the vehicle operation system 1 by the operator. Examples of the onboard device 200 include lighting devices (headlights and tail lights), direction indicators, and windshield wipers of the vehicle. Examples of the onboard device 200 also include devices inside the vehicle such as audio systems including audio devices and a radio, and an air-conditioner. Examples of the onboard device 200 further include devices that are not originally installed in the vehicle but are installed by the operator by bringing them to the vehicle, such as mobile phones and mobile audio players.

Hereinafter, unless otherwise specified, a direction parallel to the rotation axis of the steering wheel 102 is referred to as the axial direction, and a direction about the rotation axis is referred to as a circumferential direction. A direction orthogonal to the rotation axis is referred to as a radial direction.

The main operation device 10 includes a lever operation unit 11. The lever operation unit 11 includes a longitudinal member 12 projecting and extending from the steering column 101. The main operation device 10 is what is called a lever switch for operating the onboard device 200 assigned to a direction of operation in which the longitudinal member 12 is operated.

The longitudinal member 12 includes, for example, a cylindrical main body portion projecting from the steering column 101 in a certain direction. Examples of the certain direction include a radial direction, a direction slanting to the upper right of the vehicle, a direction slanting to the lower right of the vehicle, a direction slanting to the upper left of the vehicle, and a direction slanting lower left of the vehicle. Specifically, examples of the certain direction also include a direction inclined to the back of the vehicle with an end of the main body portion close to the steering column 101 being the pivot point, for each direction described above. The main body portion of the longitudinal member 12 may be a straight body, or a curved body including a curved portion in the length of the main body portion. The end of the longitudinal member 12 in the projecting direction reaches a position that can be touched by a finger of the operator gripping the left side or adjacent to the left side, or the right side or adjacent to the right side of the steering wheel 102 in the vehicle width direction of the vehicle. This configuration enables the operator to touch a distal end of the longitudinal member 12 in the projecting direction with a hand or a finger (for example, a middle finger or an index finger) while gripping the steering wheel 102.

The longitudinal member 12 is inclinably supported by a support 13 fixed inside the steering column 101. The support 13 supports the longitudinal member 12 such that the longitudinal member can easily perform an inclining action with an end of the longitudinal member 12 close to the steering column 101 being the pivot point. In the lever operation unit 11, an inclining direction of the longitudinal member 12 in an inclining action corresponds to a direction of operation in which the operator operates the longitudinal member 12. The longitudinal member 12 in this context can perform, with the neutral position being the original position, an inclining action toward the front of the vehicle, an inclining action toward the back of the vehicle, a clockwise inclining action in one circumferential direction, and a counterclockwise inclining action in the other circumferential direction. At least one onboard device 200 and at least one function of the onboard device 200 are assigned to each direction of operation of the longitudinal member 12.

The support 13 may return the longitudinal member 12 to the neutral position by, for example, spring action after the longitudinal member 12 is inclined in a certain direction of operation from the neutral position. The support 13 may also return the longitudinal member 12 to the neutral position by a manual operation by the operator after the longitudinal member 12 is inclined in a certain direction of operation from the neutral position. In the latter case, the support 13 supports the longitudinal member 12 such that the longitudinal member 12 can perform an inclining action at least one step.

The main operation device 10 includes a lever operation detecting unit 14 that detects an inclining direction of the longitudinal member 12 in an inclining action. The lever operation detecting unit 14 transmits, to the control device 30, an output signal corresponding to the inclining direction of the longitudinal member 12. The control device 30 can detect the direction of operation in which the operator operates the longitudinal member 12 on the basis of the output signal.

The control device 30 transmits a command (a drive command or a stop command) to the onboard device 200 based on the output signal from the lever operation detecting unit 14, and drives or stops a function of the onboard device 200 corresponding to the operation on the longitudinal member 12 performed by the operator. The command for the onboard device 200 may be a command to directly drive or stop the onboard device 200, or a command for a control device of the onboard device 200. When receiving the command from the control device 30, the control device of the onboard device 200 drives or stops the function of the onboard device 200 based on content of the command.

The auxiliary operation device 20 is a switch for operating another function of the onboard device 200 that is the same as an operation target of the main operation device 10, or another onboard device 200 different from the operation target of the main operation device 10. At least one operation form for operating the onboard device 200 is set to the auxiliary operation device 20. The operation form is used by the operator for showing his/her intention to operate the onboard device 200. To the operation form, at least one onboard device 200 and at least one function of the onboard device 200 are allocated.

The auxiliary operation device 20 includes an action detecting unit 21 at a distal end in a projecting direction of the longitudinal member 12. The action detecting unit 21 detects the operation form set to the auxiliary operation device 20. The action detecting unit 21 detects the operation form of the operator in operating the onboard device 200 at the distal end of the longitudinal member 12. The operation form is, for example, movement of a finger in accordance with an operational intention of the operator. Thus, the action detecting unit 21 is arranged at a position where the operator gripping the steering wheel 102 can reach the action detecting unit 21 by only stretching his/her finger.

Specifically, the action detecting unit 21 according to the first embodiment includes at least one contact operation region 22 on which the operator performs contact operation. The contact operation region 22 is formed on a contact operation member 23 arranged at the distal end in the projecting direction of the longitudinal member 12. The contact operation member 23 has an exposed portion where the operator can touch, and the contact operation region 22 is formed on the exposed portion. In the exposed portion of the exemplified contact operation member 23, an end face in the projecting direction is an operation surface for the operator. Thus, at least one contact operation region 22 is arranged on the operation surface, the contact operation region 22 being allocated in accordance with the operation form (hereinafter, referred to as a “contact operation form”) of the operator. For example, when one contact operation region 22 is provided, the action detecting unit 21 includes one contact operation member 23. On the other hand, when a plurality of contact operation regions 22 are provided, each of the contact operation regions 22 may be formed on one contact operation member 23, or may be formed on the contact operation member 23 provided for each of the contact operation regions 22.

The action detecting unit 21 includes a contact sensor 24 that can detect an object being in contact with the contact operation region 22 and a moving direction of the object. The contact sensor 24 is, for example, what is called a touch sensor such as a capacitance sensor. The contact sensor 24 is arranged on a front surface or a back surface of the operation surface of the contact operation member 23. The exemplified contact sensor 24 is arranged on the back surface of the operation surface to detect the contact operation form of the operator with respect to the contact operation region 22 of the contact operation member 23. The contact sensor 24 may be provided for each contact operation region 22, or one contact sensor 24 may be provided for a plurality of contact operation regions 22.

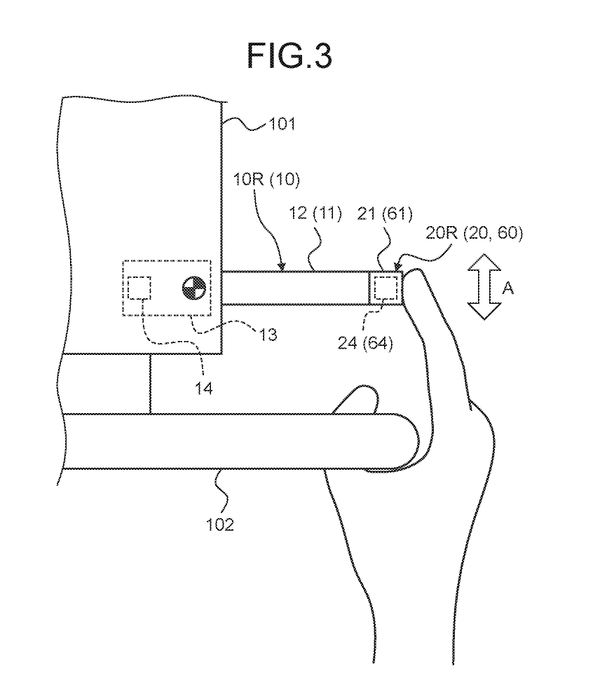

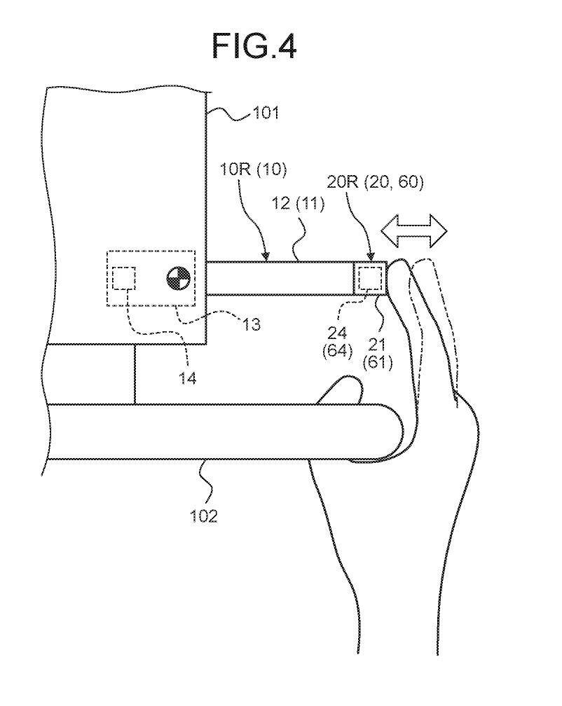

Examples of the contact operation form include a slide operation of sliding a finger touching the contact operation region 22 (FIG. 3), and a touch operation of touching the contact operation region 22 (FIG. 4). For example, selection operation functions can be allocated to the slide operation, examples of these functions including a device selection operation for selecting a desired device from among a plurality of onboard devices 200, a function selection operation for selecting a desired function from among a plurality of functions of the onboard device 200, and a condition selection operation for selecting a desired condition from among a plurality of selection conditions included in a certain function. The function selection operation means, when the onboard device 200 is audio equipment for example, an operation of selecting a desired function from among a medium selection function, a sound volume selection function, a track selection function, and the like. The condition selection operation means, for example, an operation of selecting a desired sound volume when the sound volume selection function is selected. As the slide operation, an operation in at least one direction is set. To the touch operation, for example, functions can be allocated such as a determination operation function executed in determining a function or a selection condition selected by the slide operation and a return operation function for immediately returning to a selection operation at a previous layer or a selection operation at the first layer. As the touch operation, one touch operation or a repetitive touch operation including a plurality of touches can be set.

The control device 30 transmits a command (a drive command or a stop command) to the onboard device 200 based on the output signal from the contact sensor 24 of the action detecting unit 21, and drives or stops the function of the onboard device 200 corresponding to the contact operation on the contact operation region 22 performed by the operator. The command for the onboard device 200 is the same as that exemplified above.

In the action detecting unit 21 of such a type, at least one contact operation form of the operator is allocated to one contact operation region 22. In the action detecting unit 21, the contact operation form of the operator with respect to the contact operation region 22 is allocated to each function of the onboard device 200 or each of a plurality of onboard devices 200. When the action detecting unit 21 has various selection operation functions as described above, a slide operation corresponding to each selection operation function is allocated to one or a plurality of contact operation regions 22.

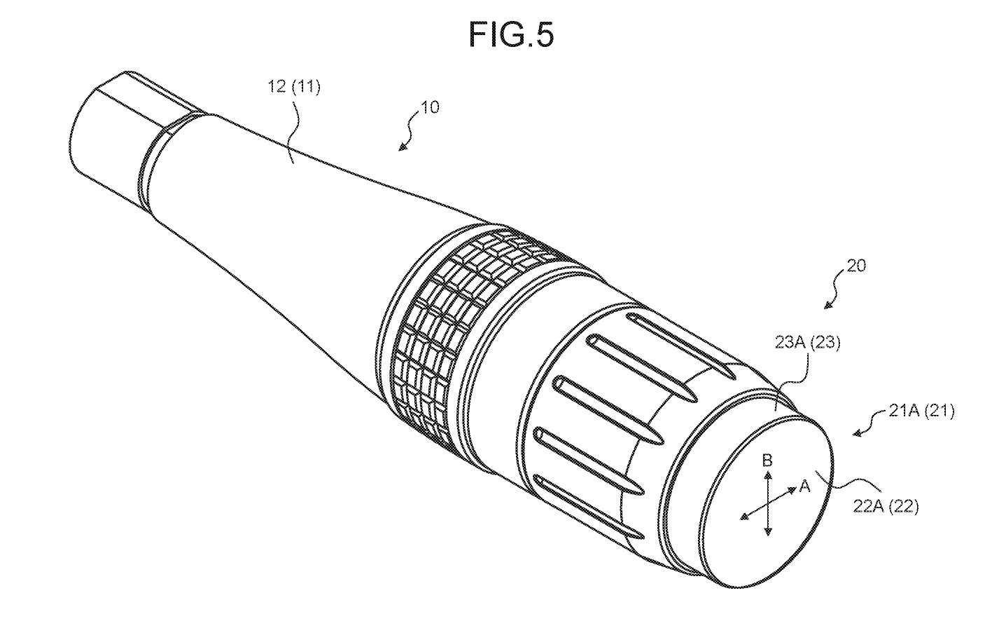

FIG. 5 illustrates a specific example of the action detecting unit 21 in a case in which one contact operation region 22 is provided.

For example, in an action detecting unit 21A in FIG. 5, a contact operation member 23A is formed in a cylindrical shape one end of which is blocked up, and arranged to close an opening at a distal end of a cylindrical main body portion of the longitudinal member 12. In this case, a circular blocking surface at an exposed portion of the contact operation member 23A is the operation surface, and the operation surface itself is a contact operation region 22A. In the action detecting unit 21A, the contact sensor 24 is arranged on the back surface of the contact operation region 22A. The exemplified operation surface is an orthogonal plane with respect to an axial direction at the distal end of the main body portion. As the contact operation form set to the contact operation region 22A, for example, a slide operation along a radial direction of the operation surface, and a touch operation of touching the contact operation region 22A are considered.

An operation direction of the slide operation (sliding direction) can be set to be any of radial directions on the blocking surface of the contact operation member 23A. However, depending on the operation direction, deviation may be caused between the operation direction and movement of a finger of the operator gripping the steering wheel 102, and a correct slide operation in accordance with a setting is difficult to be performed, which may lower the operability. Thus, in the action detecting unit 21A, the operation direction of the slide operation is preferably set in a direction along natural movement of a finger (for example, a middle finger or an index finger) of the operator gripping the steering wheel 102. Accordingly, in the action detecting unit 21A, the function of the onboard device 200 is allocated to the operation direction of the slide operation along such movement of the finger.

The natural movement of the finger of the operator means action of the finger naturally performed by the operator, that is, action of the finger with which the operator does not have a sense of incongruity. Thus, for example, the operation direction of the slide operation may be set in a direction along a bending and stretching direction of the finger (for example, a middle finger or an index finger) of the operator gripping the steering wheel 102. Thus, in the action detecting unit 21A, at least a contact operation form in the operation direction (the arrow A in FIG. 2, FIG. 3, and FIG. 5) along the bending and stretching direction of the finger of the operator gripping the steering wheel 102 is set as a detection target. The contact operation region 22A formed along the bending and stretching direction has a plane along the bending and stretching direction. In the action detecting unit 21A, a direction orthogonal to the operation direction corresponding to the bending and stretching direction may be set as an operation direction (the arrow B in FIG. 1 and FIG. 5) of another slide operation. This is because such an operation direction is also a direction along natural movement of the finger of the operator gripping the steering wheel 102. The contact operation region 22A formed along the orthogonal direction has a plane along the orthogonal direction. By setting the operation direction of the slide operation as described above, the operator can correctly perform slide operation with the auxiliary operation device 20 while gripping the steering wheel 102, which improves the operability. The contact operation region 22A may be formed on a curved surface along natural movement of the finger of the operator.

The auxiliary operation device 20 including the action detecting unit 21A can be used as at least one of the auxiliary operation devices 20L and 20R described above.

Next, the following describes a specific example of the action detecting unit 21 in a case in which a plurality of contact operation regions 22 are provided.

For example, the contact operation regions 22 may be formed by dividing the contact operation region 22A in FIG. 5. In this case, the contact sensor 24 may be arranged so that a contact operation can be sensed on the entire surface of the contact operation region 22A, and configured to be able to detect the contact operation for each of the divided regions. In a case in which a plurality of contact operation regions 22 are provided, to improve the operability in slide operation, the contact operation regions 22 are preferably formed by being divided in an orthogonal direction with respect to natural movement of the finger of the operator described above. In this case, the contact operation regions 22 are formed in a direction along the plane of the contact operation region 22A, and divided in the orthogonal direction with respect to natural movement of the finger of the operator described above. All of the contact operation regions 22 may be, for example, regions on which the slide operation is performed. Alternatively, the contact operation regions 22 may be separated into regions on which the slide operation is performed and regions on which the touch operation is performed.

However, the contact operation region 22A is a circular plane and arranged at a place that can be hardly visually recognized by the operator. Thus, in the contact operation regions 22 obtained by dividing one plane, the operator has difficulty in determining a region for performing a desired contact operation.

Accordingly, in a case in which a plurality of contact operation regions 22 are provided, for example, adjacent contact operation regions 22 are preferably formed at angles different from each other. For example, one of the adjacent contact operation regions 22 may be formed on the orthogonal plane with respect to the axial direction of the distal end of the longitudinal member 12 similarly to the contact operation region 22A. The other one of the contact operation regions 22 may be formed on a plane inclined to the orthogonal plane. Both of the contact operation regions 22 are preferably formed on a plane along natural movement of the finger of the operator described above. In this case, the other one of the contact operation regions 22 is present in a direction along the plane of one of the contact operation regions 22 and in the orthogonal direction with respect to natural movement of the finger of the operator, the other one of the contact operation regions 22 having the surface inclined to the orthogonal direction.

In a case in which a plurality of contact operation regions 22 are provided, for example, a level difference is preferably provided between the adjacent contact operation regions 22. For example, each of the adjacent contact operation regions 22 is formed on the orthogonal plane with respect to the axial direction of the distal end of the longitudinal member 12 similarly to the contact operation region 22A. In this case, with respect to one of the contact operation regions 22, the other one of the contact operation regions 22 is projected or dented in the axial direction of the distal end of the longitudinal member 12. Each of the contact operation regions 22 is preferably formed on the plane along natural movement of the finger of the operator described above. In this case, the other one of the contact operation regions 22 is present in the direction along the plane of one of the contact operation regions 22 and in the orthogonal direction with respect to natural movement of the finger of the operator, the other one of the contact operation regions 22 being projected or dented in the axial direction of the distal end of the longitudinal member 12 with respect to one of the contact operation regions 22.

In a case in which a plurality of contact operation regions 22 are provided, adjacent contact operation regions 22 may be formed at angles different from each other, and a level difference may be provided between the adjacent contact operation regions 22. Also in this case, both of the contact operation regions 22 are preferably formed on the plane along natural movement of the finger of the operator described above.

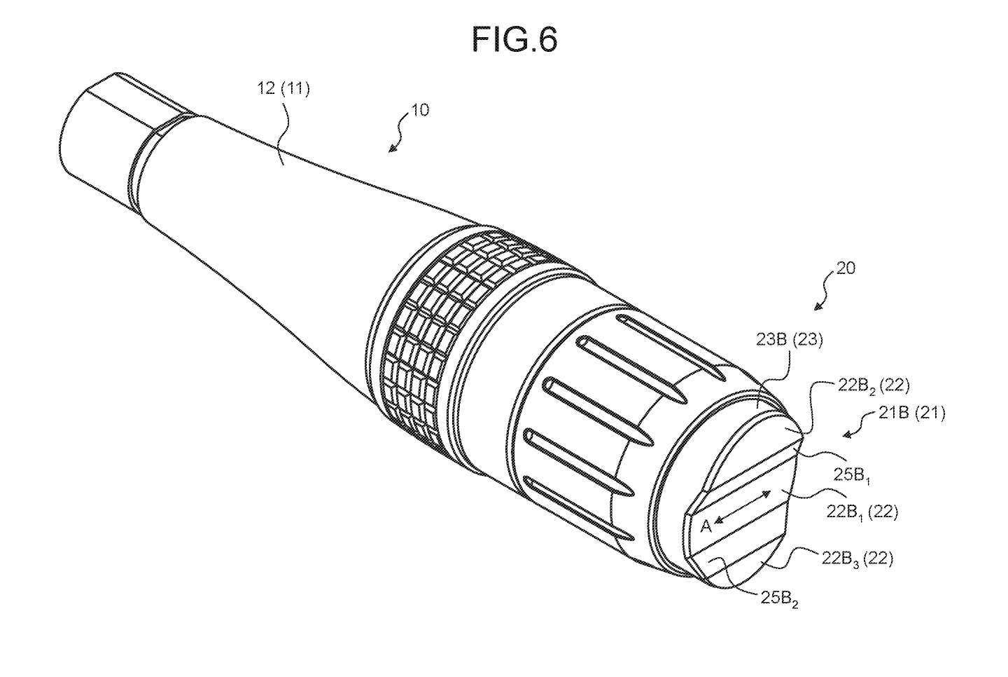

In an action detecting unit 21B illustrated in FIG. 6, a level difference is provided between adjacent contact operation regions 22. The action detecting unit 21B includes first to third contact operation regions 22B₁, 22B₂, and 22B₃. In this example, the first to third contact operation regions 22B₁, 22B₂, and 22B₃ are formed on one contact operation member 23B. The contact operation member 23B is a cylindrical member arranged at the distal end of the longitudinal member 12, and closes an opening with the first to third contact operation regions 22B₁, 22B₂, and 22B₃ that are exposed portions. The exemplified first to third contact operation regions 22B₁, 22B₂, and 22B₃ are obtained by being divided in the orthogonal direction with respect to natural movement of the finger of the operator, and each of which includes a plane along the movement. In the action detecting unit 21B, the contact sensor 24 is arranged on a back surface of the first to third contact operation regions 22B₁, 22B₂, and 22B₃.

The first contact operation region 22B₁ is interposed between the second contact operation region 22B₂ and the third contact operation region 22B₃. The first contact operation region 22B₁ is the orthogonal plane with respect to the axial direction of the distal end of the longitudinal member 12, and extended along natural movement (in this case, a bending and stretching direction) of the finger of the operator (arrow A). The first contact operation region 22B₁ is surrounded by two parallel linear sides along the movement of the finger and two sides connecting the former two sides at both ends (on a stretch side and a contraction side) of the movement of the finger. The two sides on both ends have a curvature in accordance with the cylindrical shape of the contact operation member 23B. At least a slide operation along the movement of the finger is set to the first contact operation region 22B₁ as a contact operation form. A touch operation is also set to the exemplified first contact operation region 22B₁ as a contact operation form.

The second contact operation region 22B₂ is arranged on an upper side of the vehicle with respect to the first contact operation region 22B₁. The second contact operation region 22B₂ is a plane extended along natural movement of the finger of the operator. The second contact operation region 22B₂ is surrounded by one linear side on the first contact operation region 22B₁ side along the movement of the finger, and a curved side bulging toward the upper side of the vehicle and connecting both ends of the one linear side. The curved side has a curvature in accordance with the cylindrical shape of the contact operation member 23B. At least the touch operation is set to the second contact operation region 22B₂ as a contact operation form. The slide operation along the movement of the finger may be set to the second contact operation region 22B₂ as a contact operation form.

The third contact operation region 22B₃ is arranged on a lower side of the vehicle with respect to the first contact operation region 22B₁. The third contact operation region 22B₃ is a plane extended along natural movement of the finger of the operator. The third contact operation region 22B₃ is surrounded by one linear side on the first contact operation region 22B₁ side along the movement of the finger, and a curved side bulging toward the lower side of the vehicle and connecting both ends of the one linear side. The curved side has a curvature in accordance with the cylindrical shape of the contact operation member 23B. At least the touch operation is set to the third contact operation region 22B₃ as a contact operation form. The slide operation along the movement of the finger may be set to the third contact operation region 22B₃ as a contact operation form.

In this case, the first contact operation region 22B₁ is dented toward the steering column 101 side with respect to the second contact operation region 22B₂ and the third contact operation region 22B₃. That is, in the contact operation member 23B, a level difference is provided between the first contact operation region 22B₁ and the second contact operation region 22B₂, and between the first contact operation region 22B₁ and the third contact operation region 22B₃. Thus, a connecting surface 25B₁ is formed between the first contact operation region 22B₁ and the second contact operation region 22B₂ to connect them. In addition, a connecting surface 25B₂ is formed between the first contact operation region 22B₁ and the third contact operation region 22B₃ to connect them. The contact sensor 24 may be a sensor that can detect contact of an object with the connecting surfaces 25B₁ and 25B₂, or a sensor that cannot detect such contact. In the former case, each of the connecting surfaces 25B₁ and 25B₂ may be utilized as part of the first contact operation region 22B₁, for example.

In the action detecting unit 21B, even when the operator intends to perform contact operation on the first contact operation region 22B₁, the second contact operation region 22B₂ and the third contact operation region 22B₃ may also be touched depending on the thickness of the finger of the operator. Thus, for example, when an output signal from the contact sensor 24 related to the first contact operation region 22B₁ is received and a detection region of the output signal in the first contact operation region 22B₁ is equal to or larger than a predetermined region, the control device 30 may be caused to determine that a contact operation is performed on the first contact operation region 22B₁ even when the output signal from the contact sensor 24 related to the second contact operation region 22B₂ or the third contact operation region 22B₃ is received. Each of the second contact operation region 22B₂ and the third contact operation region 22B₃ may be formed on a surface that is inclined with respect to the plane of the first contact operation region 22B₁ toward the steering column 101 side as a distance from the first contact operation region 22B₁ increases. Accordingly, in the action detecting unit 21B, an angle can be made in addition to the level difference between the first contact operation region 22B₁ and the second and third contact operation regions 22B₂ and 22B₃, which can reduce a possibility of contact with the second contact operation region 22B₂ or the third contact operation region 22B₃ due to the contact operation on the first contact operation region 22B₁. On the action detecting unit 21B, by providing such an inclined surface, the operator can more easily distinguish the contact operation regions 22B₁, 22B₂, and 22B₃ from each other, which improves the operability.

The auxiliary operation device 20 including the action detecting unit 21B can be used as at least one of the auxiliary operation devices 20L and 20R described above. For example, when the auxiliary operation device 20 including the action detecting unit 21A in FIG. 5 is used as the auxiliary operation device 20L, the auxiliary operation device 20 including the action detecting unit 21B may be used as the auxiliary operation device 20L.

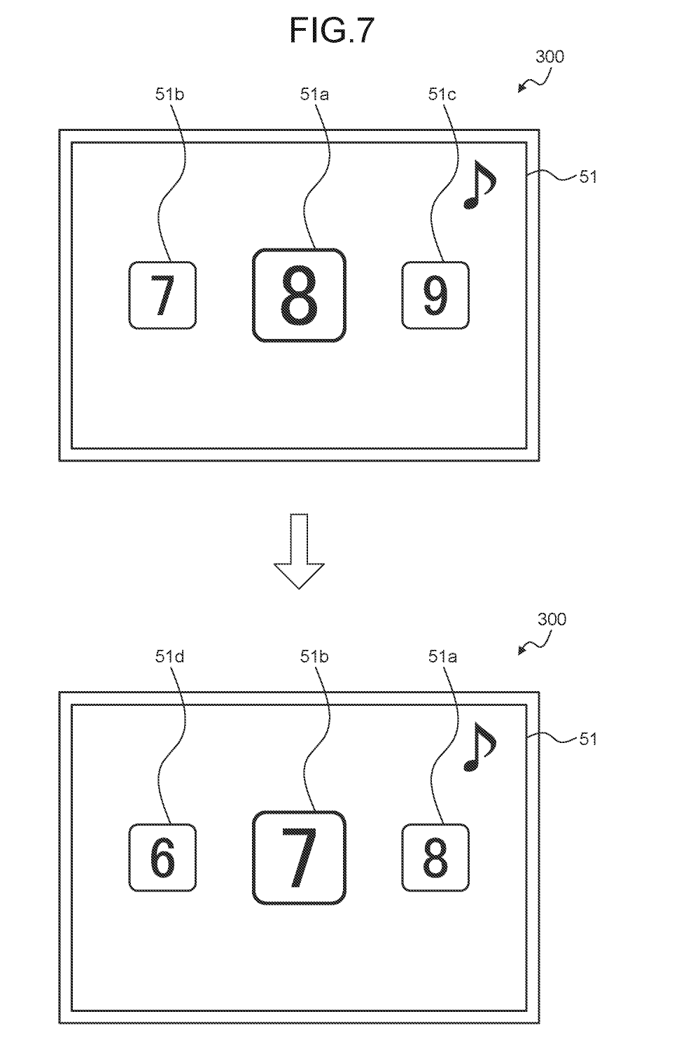

The control device 30 may cause a display device 300 inside the vehicle to display information (in this case, driving information and the like) related to the onboard device 200 in accordance with the output signal from the lever operation detecting unit 14 or the action detecting unit 21. The display device 300 is used to display information such as vehicle information to be provided to the operator in the vehicle. The display device 300 may be, for example, placed as a component of an instrument device or as a monitor of a car navigation system. For example, when the auxiliary operation device 20 is operated, the control device 30 causes the display device 300 to display an initial screen. The initial screen displays icons indicating a plurality of onboard devices 200 individually. For example, in a case of using the action detecting unit 21B in FIG. 6, the operator performs slide operation on at least one of the first to third contact operation regions 22B₁, 22B₂, and 22B₃ (in this case, the first contact operation region 22B₁) in any one direction, and performs touch operation (operation of touching once) on the second contact operation region 22B₂ at a position where the icon of a desired onboard device 200 is emphasized to select the onboard device 200. For example, when the selected onboard device 200 is audio equipment, the control device 30 causes the display device 300 to display icons individually indicating various functions of the audio equipment in accordance with the touch operation. The operator performs slide operation on the first contact operation region 22B₁ in any one direction, and performs touch operation on the second contact operation region 22B₂ at a position where the icon of a desired function is emphasized to select the function of the audio equipment. For example, when the selected function is the sound volume selection function of the audio equipment, the display device 300 displays a sound volume selection screen 51 including an emphasized icon 51a related to current sound volume and icons 51b and 51c related to sound volume that can be selected before and after the current sound volume (the upper diagram in FIG. 7). The icon 51a of the current sound volume is emphasized as compared with the other icons 51b and 51c. The operator performs slide operation on the first contact operation region 22B₁ in any one direction to select desired sound volume. The control device 30 raises or lowers the sound volume of the audio equipment in accordance with the slide operation, causes the selected icon 51b to be emphasized in the sound volume selection screen 51, and causes the icons 51a and 51d related to the sound volume that can be selected before and after the icon 51b to be displayed (the lower diagram in FIG. 7). When the icon related to the desired sound volume is emphasized, the operator performs touch operation (operation of touching once) on the second contact operation region 22B₂ to instruct the control device 30 to determine the sound volume. When selection and determination are repeated through a plurality of layers, the process can move one layer up or return to the topmost first layer by performing touch operation on the third contact operation region 22B₃.

The auxiliary operation device 20 configured as described above has excellent operability. In the vehicle operation system 1 according to the first embodiment, a direction along natural movement of the finger of the operator gripping the steering wheel 102 is selected as the operation direction of the slide operation. Specifically, a direction along the bending and stretching direction of the finger while the steering wheel 102 is gripped or a direction orthogonal to the direction along the bending and stretching direction is selected as the operation direction of the slide operation. Thus, with the vehicle operation system 1, the operator can perform slide operation set in advance by moving his/her finger without a sense of incongruity. Accordingly, the vehicle operation system 1 can reduce a burden on the finger of the operator performing slide operation. The slide operation is utilized particularly for the selection operation such as the function selection operation or the condition selection operation as described above, so that, among various operation forms, the slide operation requires large reciprocating motion of the finger. Additionally, the large reciprocating motion of the finger may be repeated in some cases. The vehicle operation system 1 according to the first embodiment can reduce a burden on the finger of the operator under such an operation situation.

First Modification

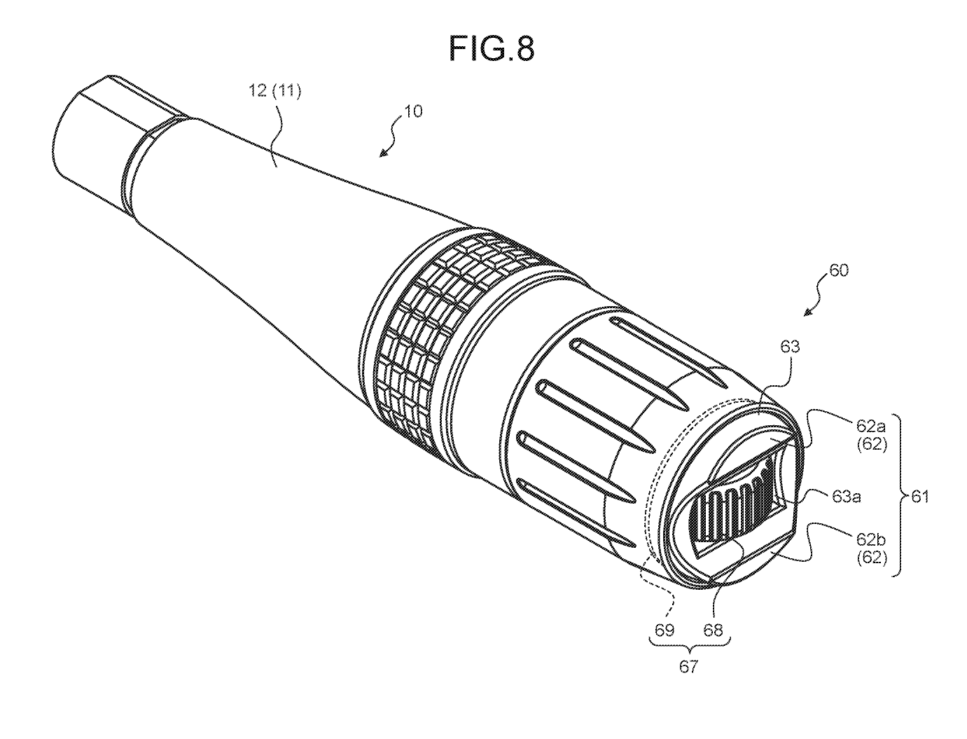

In a vehicle operation system 2 according to a first modification, the auxiliary operation device 20 in the vehicle operation system 1 according to the first embodiment described above is replaced with an auxiliary operation device 60 illustrated in FIG. 8. Similarly to the auxiliary operation device 20 according to the first embodiment, a plurality of operation forms for operating the onboard device 200 are set to the auxiliary operation device 60.

The auxiliary operation device 60 includes, as action detecting units, a first action detecting unit 61 that is the same as the auxiliary operation device 20 according to the first embodiment and a second action detecting unit 67 different from the auxiliary operation device 20 at a distal end in a projecting direction of the longitudinal member 12.

The first action detecting unit 61 according to the first modification includes an operation surface at the distal end in the projecting direction of the longitudinal member 12 similarly to the action detecting unit 21 according to the first embodiment, and a contact operation region 62 is arranged on the operation surface. The exemplified operation surface includes a first contact operation region 62a and a second contact operation region 62b as the contact operation region 62. The first contact operation region 62a and the second contact operation region 62b are arranged with a gap therebetween on an exposed portion of a contact operation member 63. The contact operation member 63 is a cylindrical member similar to the contact operation member 23A in FIG. 5 according to the first embodiment, and a rectangular through hole 63a is arranged at a center portion of a circular blocking surface that is the exposed portion. The first contact operation region 62a and the second contact operation region 62b are arranged with the through hole 63a interposed therebetween. A longitudinal direction of the through hole 63a is preferably the direction along natural movement of the finger of the operator gripping the steering wheel 102 described in the first embodiment. In this example, the bending and stretching direction of the finger is the longitudinal direction of the through hole 63a. A contact sensor 64 similar to the contact sensor 24 according to the first embodiment is arranged on a front surface or a back surface of the exposed portion of the contact operation member 63 (FIG. 1). The contact sensor 64 for the first contact operation region 62a and the contact sensor 64 for the second contact operation region 62b may be individually prepared.

The first contact operation region 62a is arranged on the upper side of the vehicle with respect to the through hole 63a. The first contact operation region 62a is surrounded by one linear side on the through hole 63a side along natural movement of the finger of the operator, and a curved side bulging toward the upper side of the vehicle and connecting both ends of the one linear side. The curved side has a curvature in accordance with the cylindrical shape of the contact operation member 63. The contact sensor 64 is arranged on the back surface of the first contact operation region 62a. At least the touch operation is set to the first contact operation region 62a as a contact operation form. For example, the touch operation (operation of touching once) on the first contact operation region 62a can be utilized as a determination button similarly to the second contact operation region 22B₂ according to the first embodiment. The slide operation along the movement of the finger of the operator may be set to the first contact operation region 62a as a contact operation form.

The second contact operation region 62b is arranged on the lower side of the vehicle with respect to the through hole 63a. The second contact operation region 62b is surrounded by one linear side on the through hole 63a side along natural movement of the finger of the operator, and a curved side bulging toward the lower side of the vehicle and connecting both ends of the one linear side. The curved side has a curvature in accordance with the cylindrical shape of the contact operation member 63. The contact sensor 64 is arranged on the back surface of the second contact operation region 62b. At least the touch operation is set to the second contact operation region 62b as a contact operation form. For example, the touch operation (operation of touching once) on the second contact operation region 62b can be utilized as a back button similarly to the third contact operation region 22B₃ according to the first embodiment. The slide operation along the movement of the finger of the operator may be set to the second contact operation region 62b as a contact operation form.

The second action detecting unit 67 includes a movable operation member 68 that works when the operator performs contact operation and an operation detecting unit 69 that detects movement of the movable operation member 68, and detects the contact operation form of the operator with respect to the movable operation member 68. In this example, a disc-shaped dial operation member 68 is arranged as the movable operation member 68. Thus, a dial operation detecting unit 69 that detects the movement of the dial operation member 68 is arranged as the operation detecting unit 69. The second action detecting unit 67 is configured similarly to what is called a tilt wheel.

The dial operation member 68 is arranged so that an axis of itself (rotation shaft) intersects with the axial direction of the distal end of the longitudinal member 12 at right angles in a state in which part of an outer peripheral surface of the dial operation member 68 is exposed from the through hole 63a, and the dial operation member 68 can rotate about the axis along the longitudinal direction of the through hole 63a. Thus, the dial operation member 68 can perform rotation operation about the axis along natural movement of the finger of the operator gripping the steering wheel 102 (the bending and stretching direction of the finger of the operator). The dial operation member 68 is rotatably held with respect to the contact operation member 63, for example. In the dial operation member 68, the portion exposed from the through hole 63a is a part on which the contact operation is performed by the operator. Thus, to prevent slippage in the contact operation, a recessed part and a projecting part are alternately formed on the outer peripheral surface along a circumferential direction. The dial operation member 68 is also configured to be depressable along the axial direction of the distal end of the longitudinal member 12. The depressed dial operation member 68 can be returned to an original position due to an elastic member (not illustrated) attached to a rotation shaft or a holding part of the rotation shaft, for example.

The rotation operation about the axis of the dial operation member 68 can be used as an operation corresponding to the slide operation in the first contact operation region 22B₁ according to the first embodiment. The depressing operation of the dial operation member 68 can be utilized as a determination operation for a selected function of the onboard device 200, for example.

The dial operation detecting unit 69 detects a rotation operation amount of the dial operation member 68 (for example, a rotation angle), and detects whether the dial operation member 68 is depressed. The dial operation detecting unit 69 transmits an output signal related to the rotation operation amount or the depression of the dial operation member 68 to the control device 30. The dial operation detecting unit 69 is used for detecting the contact operation on the dial operation member 68 performed by the operator, which can be regarded as a contact sensor.

The control device 30 controls the onboard device 200 based on output signals from the contact sensor 64 and the dial operation detecting unit 69.

The auxiliary operation device 60 can be used as at least one of the auxiliary operation devices 20L and 20R described in the first embodiment. In the vehicle operation system 2, the auxiliary operation device 60 may be applied to one of the auxiliary operation devices 20L and 20R, and the auxiliary operation device 20 including the action detecting unit 21A or the action detecting unit 21B according to the first embodiment may be applied to the other one thereof.

As described above, in the second action detecting unit 67 of the auxiliary operation device 60 according to the first modification, the direction along natural movement of the finger of the operator gripping the steering wheel 102 is set as a rotation operation direction about the axis of the dial operation member 68. Specifically, the direction along the bending and stretching direction of the finger while the steering wheel 102 is gripped or the direction orthogonal to the direction along the bending and stretching direction is set as the rotation operation direction about the axis of the dial operation member 68. Thus, with the vehicle operation system 2 according to the first modification, the operator can perform rotation operation about the axis of the dial operation member 68 set in advance by moving his/her finger without a sense of incongruity. Accordingly, the vehicle operation system 2 can reduce a burden on the finger of the operator rotating the dial operation member 68. The rotation operation of the dial operation member 68 is utilized for the selection operation such as the function selection operation or the condition selection operation similarly to the slide operation, so that, among various operation forms, the rotation operation requires large reciprocating motion of the finger. Additionally, the large reciprocating motion of the finger may be repeated in some cases. The vehicle operation system 2 according to this modification can reduce a burden on the finger of the operator under such an operation situation.

Second Modification

In the vehicle operation system 1 according to the first embodiment and the vehicle operation system 2 according to the first modification described above, the contact operation form is employed as an operation form of the operator for the auxiliary operation devices 20 and 60. In contrast, for an auxiliary operation device 70 of a vehicle operation system 3 according to a second modification, a non-contact operation form is used as the operation form of the operator.

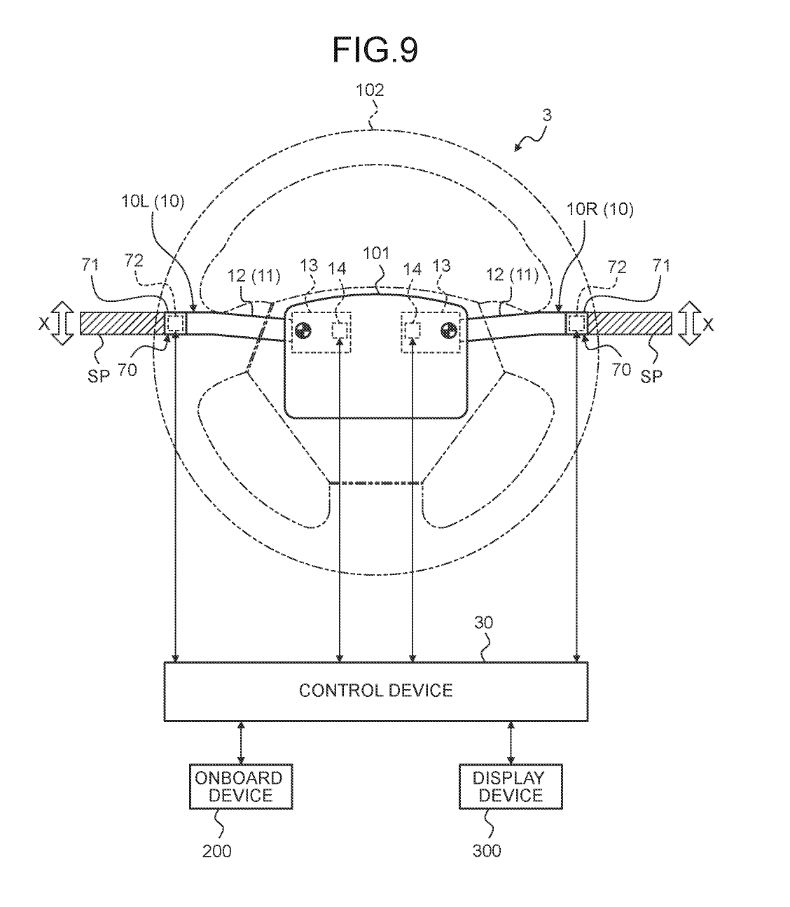

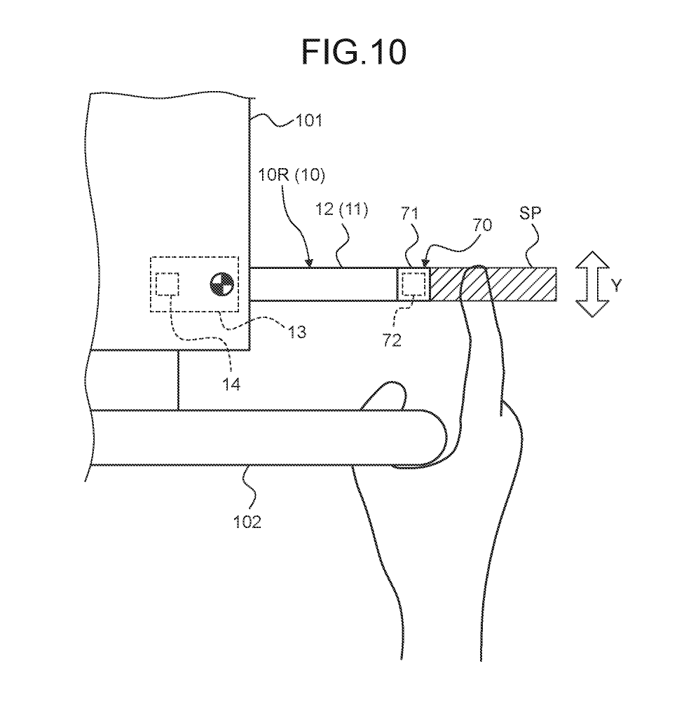

In the vehicle operation system 3 according to the second modification, the auxiliary operation device 20 in the vehicle operation system 1 according to the first embodiment described above is replaced with the auxiliary operation device 70 illustrated in FIG. 9 and FIG. 10. Similarly to the auxiliary operation device 20 according to the first embodiment, a plurality of operation forms for operating the onboard device 200 are set to the auxiliary operation device 70.

The auxiliary operation device 70 includes, at the distal end in the projecting direction of the longitudinal member 12, an action detecting unit 71 that detects the operation form of the operator in a non-contact state. The action detecting unit 71 can detect the operation form of the operator in a sensing space SP with the distal end of the longitudinal member 12 being a base point. The sensing space SP is, for example, a space at least extending from a tip of the distal end of the longitudinal member 12 toward a side part of the vehicle along the axial direction of the distal end. The action detecting unit 71 includes a non-contact sensor 72 that can detect an object present in the sensing space SP and a moving direction of the object in the sensing space SP. For example, an infrared sensor such as a near-infrared sensor can be used as the non-contact sensor 72. The near-infrared sensor includes, for example, a light emitting unit including a light emitting diode, a light receiving unit including a photodiode, and a signal processing unit that performs signal processing related to the light emitting unit and the light receiving unit. The near-infrared sensor can grasp the operation form of the operator in the sensing space SP based on light (modulated light) emitted from the light emitting unit to the sensing space SP and reflected light of the light received by the light receiving unit. Specifically, the near-infrared sensor includes first to fourth photodiodes arranged in a lattice pattern of 2×2. In the near-infrared sensor, the first photodiode is arranged in the first row and the first column, the second photodiode is arranged in the second row and the first column, the third photodiode is arranged in the first row and the second column, and the fourth photodiode is arranged in the second row and the second column. The near-infrared sensor also includes a light emitting diode arranged side by side with the second photodiode and the fourth photodiode. In a case of using the near-infrared sensor having such an arrangement, the control device 30 calculates the sum of output signals from the first and the second photodiodes in the first column and the sum of output signals from the third and the fourth photodiodes in the second column, and a difference between the sums (first difference) is calculated as an output signal in a first direction. The control device 30 calculates the sum of output signals from the first and the third photodiodes in the first row and the sum of output signals from the second and the fourth photodiodes in the second row, and a difference between the sums (second difference) is calculated as an output signal in a second direction. The control device 30 determines that an object moving in a direction of a larger output signal of the first difference and the second difference is detected.

In the action detecting unit 71, the operation form of the operator in the sensing space SP is allocated for each function of the onboard device 200 or each of the onboard devices 200. In the action detecting unit 71, the slide operation is allocated as the operation form in accordance with various selection operation functions as described in the first embodiment. As the operation form to be allocated, the operation form in accordance with natural movement of the finger of the operator gripping the steering wheel 102 as described in the first embodiment is preferably applied. For example, when receiving an output signal related to movement of the finger in a finger waving direction from the non-contact sensor 72, the control device 30 can recognize a finger waving operation in the sensing space SP to be equivalent to the slide operation according to the first embodiment. The finger waving direction is the arrow-X direction in FIG. 9 orthogonal to the direction along the bending and stretching direction of the finger. When receiving the output signal related to the movement along the bending and stretching direction of the finger from the non-contact sensor 72, the control device 30 can recognize a bending and stretching operation (an operation in the arrow-Y direction in FIG. 10) of the finger in the sensing space SP to be equivalent to the slide operation on the first contact operation region 22B₁ according to the first embodiment. When the non-contact sensor 72 detects that a distance to the finger becomes small similarly to the touch operation according to the first embodiment, the control device 30 receives the output signal from the non-contact sensor 72 and recognizes the movement of the finger in the sensing space SP to be equivalent to the touch operation according to the first embodiment. The operation form of the operator in the sensing space SP includes not only the non-contact operation within the sensing space SP but also a contact operation on the action detecting unit 71 exposed in the sensing space SP. The sensing space SP may be set, for example, to be an annular space for covering the outer peripheral surface of the distal end of the longitudinal member 12.

The auxiliary operation device 70 may be used as at least one of the auxiliary operation devices 20L and 20R described in the first embodiment. In the vehicle operation system 3, the auxiliary operation device 70 may be applied to one of the auxiliary operation devices 20L and 20R, and the auxiliary operation device 20 or 60 according to the first embodiment or the first modification may be applied to the other one thereof.

As described above, in the action detecting unit 71 of the auxiliary operation device 70 according to the second modification, the direction along natural movement of the finger of the operator gripping the steering wheel 102 is set as an operation direction of the finger in the sensing space SP. Specifically, the direction along the bending and stretching direction of the finger while the steering wheel 102 is gripped or the direction orthogonal to the direction along the bending and stretching direction is set as the operation direction of the finger in the sensing space SP. Thus, with the vehicle operation system 3 according to the second modification, the operator can perform operation set in advance as the operation form in the sensing space SP by moving his/her finger without a sense of incongruity. Accordingly, the vehicle operation system 3 can reduce a burden on the finger of the operator in performing operation in the sensing space SP. The finger waving operation and the bending and stretching operation of the finger are particularly utilized for the selection operation such as the function selection operation or the condition selection operation similarly to the slide operation, so that, among various operation forms in the sensing space SP, these operations require large reciprocating motion of the finger. Additionally, the large reciprocating motion of the finger may be repeated in some cases. The vehicle operation system 3 according to the second modification can reduce a burden on the finger of the operator under such an operation situation.

In the description of the first embodiment and the first and second modifications, each of the auxiliary operation devices 20, 60, and 70 is arranged at the distal end of the longitudinal member 12 that can perform inclining action in the main operation device 10. However, the action detecting units 21 and 71 of the auxiliary operation devices 20 and 70 or the first and second action detecting units 61 and 67 of the auxiliary operation device 60 may be arranged at the distal end of an immovable longitudinal member 12 the movement of which such as inclining action is prohibited. The immovable longitudinal member 12 is a long object that is projected and extended from the steering column 101, and one end thereof is fixed to the inside of the steering column 101. At least one of a combination of the immovable longitudinal member 12 and the action detecting unit 21, a combination of the longitudinal member 12 and the first and second action detecting units 61 and 67, and a combination of the longitudinal member 12 and the action detecting unit 71 may be arranged on at least one of the left end and the right end in a vehicle width direction of the steering column 101. This combination may be arranged in place of the combination of the main operation device 10 and the auxiliary operation device 20 described above, or may be arranged in addition to the combination of the main operation device 10 and the auxiliary operation device 20.

An auxiliary operation device (not illustrated) different from the auxiliary operation devices 20, 60, and 70 may be additionally arranged in the main operation device 10. The additional auxiliary operation device includes, for example, a concentric annular member arranged for covering the outer peripheral surface of the longitudinal member 12, and selects a function of the onboard device 200 by rotating the annular member about the axis.

### Second Embodiment

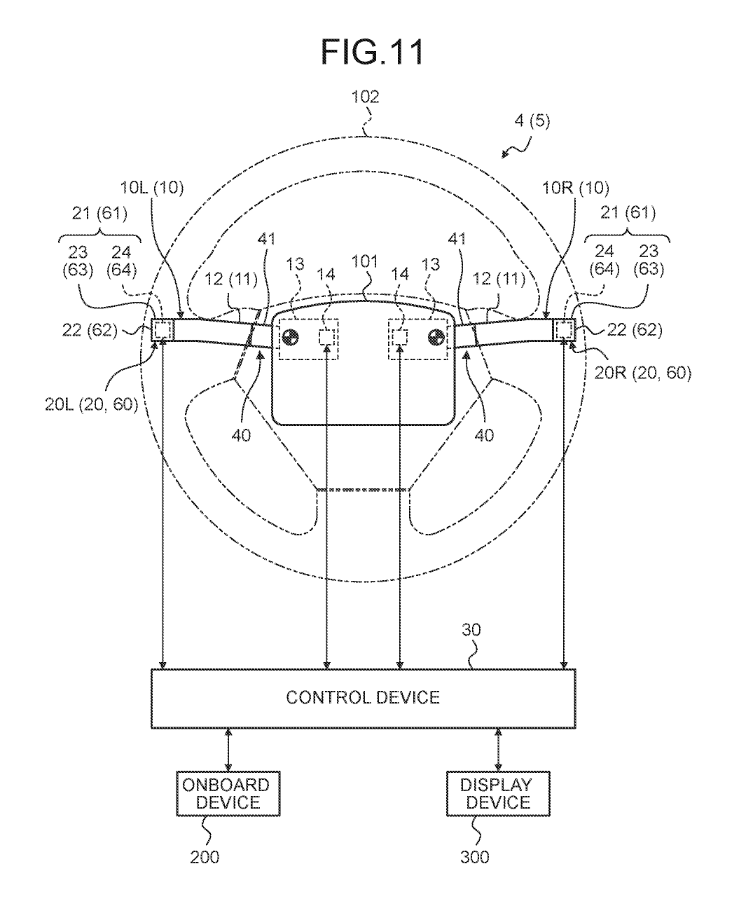

The following describes a second embodiment of the vehicle operation system according to the present invention based on FIG. 11 to FIG. 15.

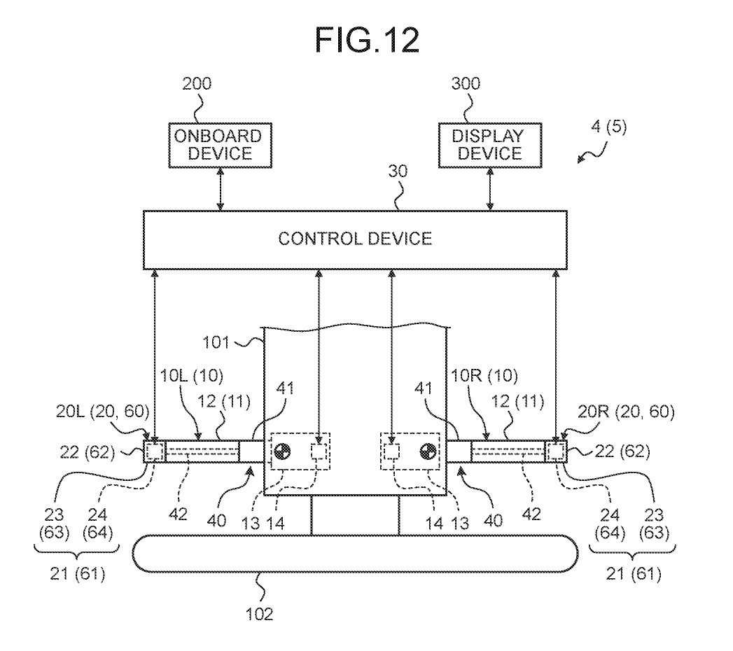

The vehicle operation system according to the second embodiment is configured so that the operator (driver) can operate the onboard device mounted on the vehicle without removing his/her hand from the steering wheel. The reference sign 4 in FIG. 11 and FIG. 12 denotes a vehicle operation system having such a configuration.

The vehicle operation system 4 according to the second embodiment includes the main operation device 10 and the auxiliary operation device 20 arranged in the steering column 101 inside the vehicle for operating the onboard device 200, the control device (controller) 30, and other devices similarly to the vehicle operation system 1 according to the first embodiment. The configuration, the action, and the like of these devices are the same as those in the vehicle operation system 1 according to the first embodiment. Thus, redundant description will not be repeated, and differences will be mainly described below.

The auxiliary operation device 20 includes the action detecting unit 21 at the distal end in the projecting direction of the longitudinal member 12. The action detecting unit 21 detects the operation form set to the auxiliary operation device 20. The action detecting unit 21 detects the operation form in accordance with an operational intention of the operator with respect to the onboard device 200 at the distal end of the longitudinal member 12.

Specifically, the action detecting unit 21 according to the second embodiment includes at least one contact operation region (distal end surface) 22 on which the operator performs contact operation. The contact operation region 22 is formed on the contact operation member 23 arranged at the distal end of the longitudinal member 12. The contact operation member 23 has an exposed portion where the operator can touch, and the contact operation region 22 is formed on the exposed portion. For example, when one contact operation region 22 is provided, the action detecting unit 21 includes one contact operation member 23. On the other hand, when a plurality of contact operation regions 22 are provided, each of the contact operation regions 22 may be formed on one contact operation member 23, or may be formed on the contact operation member 23 provided for each of the contact operation regions 22.

The action detecting unit 21 includes the contact sensor 24 that can detect an object being in contact with the contact operation region 22 and a moving direction of the object. The contact sensor 24 is, for example, what is called a touch sensor such as a capacitance sensor. The contact sensor 24 is arranged on the front surface or the back surface of the exposed portion of the contact operation member 23. The exemplified contact sensor 24 is arranged on the back surface of the exposed portion to detect the operation form (hereinafter, referred to as a “contact operation form”) of the operator with respect to the contact operation region 22 of the contact operation member 23. The contact sensor 24 may be provided for each contact operation region 22, or one contact sensor 24 may be provided for a plurality of contact operation regions 22.

The control device 30 transmits a command (a drive command or a stop command) to the onboard device 200 based on the output signal from the contact sensor 24 of the action detecting unit 21, and drives or stops the function of the onboard device 200 corresponding to the contact operation on the contact operation region 22 performed by the operator. The command for the onboard device 200 is the same as that exemplified above.

In the action detecting unit 21 of such a type, at least one contact operation form of the operator is allocated to one contact operation region 22. In the action detecting unit 21, the contact operation form of the operator with respect to the contact operation region 22 is allocated to each function of the onboard device 200 or each of a plurality of onboard devices 200.

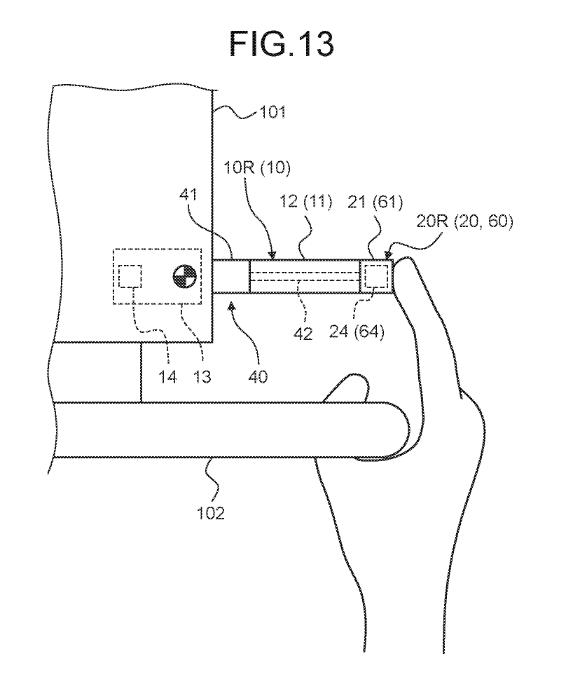

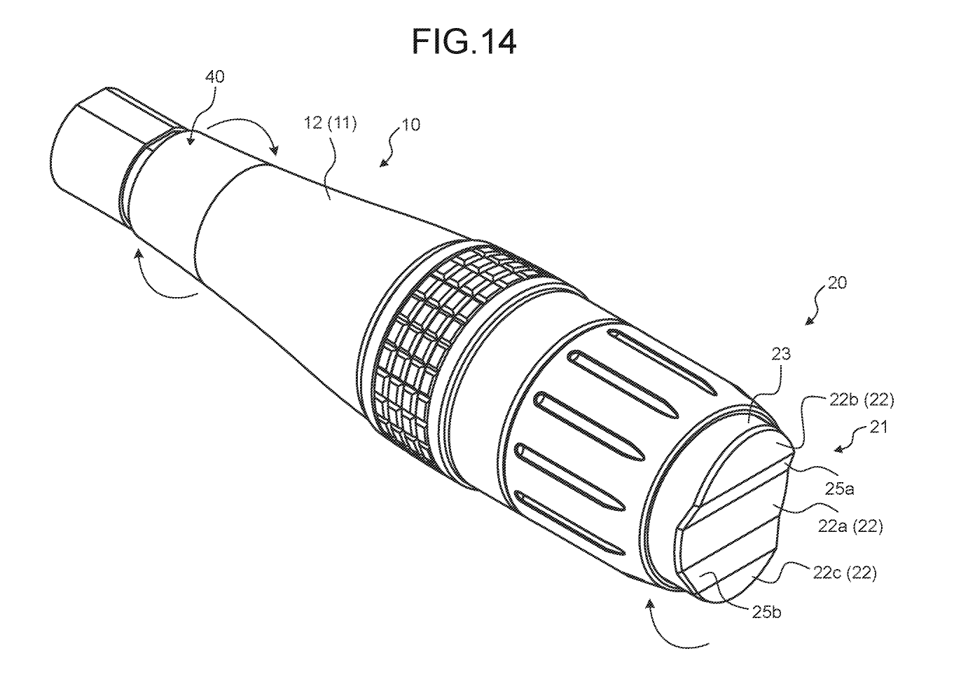

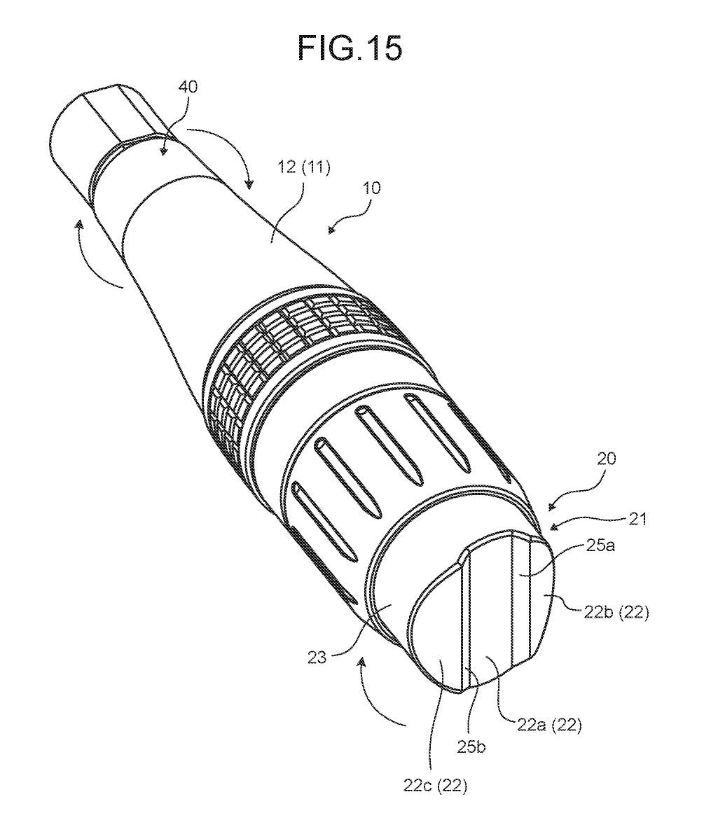

In the action detecting unit 21 illustrated in FIG. 14 and FIG. 15, the contact operation member 23 is formed in a cylindrical shape one end of which is blocked up, and arranged to close the opening at the distal end of the cylindrical main body portion of the longitudinal member 12. In this case, first to third contact operation regions 22a, 22b, and 22c (described later) are arranged as the contact operation regions 22. A circular blocking surface that is the exposed portion of the contact operation member 23 is the contact operation region 22. The action detecting unit 21 includes the contact sensor (for example, refer to FIG. 11) 24 arranged on the back surface of the contact operation region 22. In this case, the contact sensor 24 (for example, refer to FIG. 13) may be arranged so that the contact operation can be sensed on the entire surface of the contact operation region 22, and configured to be able to detect the contact operation for each of the divided regions.

The exemplified blocking surface is an orthogonal plane with respect to an axial direction at the distal end of the main body portion. As the contact operation form set to the contact operation region 22, for example, a slide operation along a radial direction of the blocking surface, and a touch operation of touching the contact operation region 22 are considered. For example, the slide operation can be used for a function selection operation for selecting a desired function from among a plurality of functions of the onboard device 200 and a condition selection operation for selecting a desired condition from among a plurality of selection conditions included in a certain function. The function selection operation means, when the onboard device 200 is audio equipment for example, an operation of selecting a desired function from among a medium selection function, a sound volume selection function, a track selection function, and the like. The condition selection operation means, for example, an operation of selecting a desired sound volume when the sound volume selection function is selected. As the slide operation, an operation in at least one direction is set. The touch operation means, for example, an operation executed in determining a function or a selection condition selected by the slide operation. As the touch operation, one touch operation or a repetitive touch operation including a plurality of touches can be set.

To improve the operability in slide operation, the contact operation regions 22 are preferably formed by being divided in an orthogonal direction with respect to natural movement of the finger of the operator. In this case, the contact operation regions 22 are formed in a direction along the plane of the contact operation region 22, and divided in the orthogonal direction with respect to natural movement of the finger of the operator.

The action detecting unit 21 includes first to third contact operation regions 22a, 22b, and 22c. In this example, the first to third contact operation regions 22a, 22b, and 22c are formed on one contact operation member 23. The contact operation member 23 is a cylindrical member arranged at the distal end of the longitudinal member 12, and closes an opening with the first to third contact operation regions 22a, 22b, and 22c that are exposed portions. The exemplified first to third contact operation regions 22a, 22b, and 22c are obtained by being divided in the orthogonal direction with respect to natural movement of the finger of the operator, and each of which includes a plane along the movement. In the action detecting unit 21, the contact sensor 24 is arranged on a back surface of the first to third contact operation regions 22a, 22b, and 22c.

The first contact operation region 22a is interposed between the second contact operation region 22b and the third contact operation region 22c. The first contact operation region 22a is the orthogonal plane with respect to the axial direction of the distal end of the longitudinal member 12, and extended along natural movement (in this case, a bending and stretching direction) of the finger of the operator. The first contact operation region 22a is surrounded by two parallel linear sides along the movement of the finger and two sides connecting the former two sides at both ends (on a stretch side and a contraction side) of the movement of the finger. The two sides on both ends have a curvature in accordance with the cylindrical shape of the contact operation member 23. At least a slide operation along the movement of the finger is set to the first contact operation region 22a as a contact operation form. A touch operation is also set to the exemplified first contact operation region 22a as a contact operation form.

The second contact operation region 22b is arranged on the upper side of the vehicle with respect to the first contact operation region 22a. The second contact operation region 22b is a plane that is inclined to the first contact operation region 22a and extended along natural movement of the finger of the operator. The second contact operation region 22b is inclined to be closer to the steering column 101 toward the upper side of the vehicle with respect to the first contact operation region 22a. That is, the exemplified second contact operation region 22b has an inclined surface as if it is obtained by chamfering part of a periphery of a disc. The second contact operation region 22b is surrounded by one linear side on the first contact operation region 22a side along the movement of the finger, and a curved side bulging toward the upper side of the vehicle and connecting both ends of the one linear side. The curved side has a curvature in accordance with the cylindrical shape of the contact operation member 23. At least the touch operation is set to the second contact operation region 22b as a contact operation form. The slide operation along the movement of the finger may be set to the second contact operation region 22b as a contact operation form.

The third contact operation region 22c is arranged on the lower side of the vehicle with respect to the first contact operation region 22a. The third contact operation region 22c is a plane that is inclined to the first contact operation region 22a and extended along natural movement of the finger of the operator. The third contact operation region 22c is inclined to be closer to the steering column 101 toward the lower side of the vehicle with respect to the first contact operation region 22a. That is, the exemplified third contact operation region 22c has an inclined surface as if it is obtained by chamfering part of a periphery of a disc similarly to the second contact operation region 22b. The third contact operation region 22c is surrounded by one linear side on the first contact operation region 22a side along the movement of the finger, and a curved side bulging toward the lower side of the vehicle and connecting both ends of the one linear side. The curved side has a curvature in accordance with the cylindrical shape of the contact operation member 23. At least the touch operation is set to the third contact operation region 22c as a contact operation form. The slide operation along the movement of the finger may be set to the third contact operation region 22c as a contact operation form.

In this case, the first contact operation region 22a is dented toward the steering column 101 side with respect to the second contact operation region 22b and the third contact operation region 22c. That is, in the contact operation member 23, a level difference is provided between the first contact operation region 22a and the second contact operation region 22b, and between the first contact operation region 22a and the third contact operation region 22c. Thus, a connecting surface 25a is formed between the first contact operation region 22a and the second contact operation region 22b to connect them. In addition, a connecting surface 25b is formed between the first contact operation region 22a and the third contact operation region 22c to connect them. The contact sensor 24 may be a sensor that can detect contact of an object with respect to the connecting surfaces 25a and 25b, or a sensor that cannot detect such contact. In the former case, each of the connecting surfaces 25a and 25b may be utilized as part of the first contact operation region 22a, for example.

In the action detecting unit 21, even when the operator intends to perform contact operation on the first contact operation region 22a, the second contact operation region 22b and the third contact operation region 22c may also be touched depending on the thickness of the finger of the operator. Thus, for example, when an output signal from the contact sensor 24 related to the first contact operation region 22a is received and a detection region of the output signal in the first contact operation region 22a is equal to or larger than a predetermined region, the control device 30 may be caused to determine that a contact operation is performed on the first contact operation region 22a even when the output signal from the contact sensor 24 related to the second contact operation region 22b or the third contact operation region 22c is received.

The auxiliary operation device 20 including the action detecting unit 21 can be used as at least one of the auxiliary operation devices 20L and 20R described above.

The thus configured vehicle operation system 1 includes a rotation mechanism 40. The rotation mechanism 40 causes the action detecting unit 21 to rotate about the axis in the extending direction (distal end) of the longitudinal member 12. The rotation mechanism 40 causes at least the contact operation member 23 to rotate about the axis of the distal end of the longitudinal member 12. The rotation mechanism 40 mainly includes a rotation part 41 and a transmission shaft 42. The rotation part 41 is arranged on the steering column 101 side of the longitudinal member 12. The rotation part 41 is, for example, formed to have a concentric annular shape arranged for covering the outer peripheral surface of the longitudinal member 12. The transmission shaft 42 is arranged inside the longitudinal member 12. The transmission shaft 42 connects the rotation part 41 with the contact operation member 23. The transmission shaft 42 transmits rotation of the rotation part 41 to the contact operation member 23. If the longitudinal member 12 has a curved portion in the length of the longitudinal member 12, a link mechanism in accordance with the curved portion of the longitudinal member 12 may be provided to the transmission shaft 42 in the rotation mechanism 40, for example.

With the rotation mechanism 40 having such a configuration, the contact operation member 23 can steplessly rotate about the axis. For example, when the operator intends to perform slide operation of bending and stretching his/her finger in a reciprocating back and forth direction between the front side of the vehicle and the rear side of the vehicle while gripping the steering wheel 102, as illustrated in the example of FIG. 14, the operator rotates the contact operation member 23 so that the first contact operation region 22a extends along the reciprocating back and forth direction connecting the front side of the vehicle and the rear side of the vehicle. When the operator intends to perform slide operation of waving the finger in the vertical direction while gripping the steering wheel 102, as illustrated in the example of FIG. 15, the operator rotates the contact operation member 23 so that the first contact operation region 22a extends along the vertical direction of the vehicle. The rotation mechanism 40 may cause the contact operation member 23 to rotate about the axis in a stepwise manner by a predetermined angle, for example.

In this way, the operator may cause the contact operation member 23 to rotate about the axis so that the first contact operation region 22a extends along a direction in which the operator can easily move his/her finger while gripping the steering wheel 102. That is, with the vehicle operation system 1, a direction of finger action based on which the onboard device 200 is operated can be set for each operator. When the operator of the vehicle is replaced with another person, the new operator may cause the contact operation member 23 to rotate about the axis so that the first contact operation region 22a extends along a direction in which the new operator can easily move his/her finger while gripping the steering wheel 102. Thus, with the vehicle operation system 4, various operators can easily change orientation of the first contact operation region 22a in accordance with an operation direction of the finger desired by the operator even when a gripping position on the steering wheel 102 is different for each of the operators.

As described above, the vehicle operation system 4 according to the second embodiment can improve the operability.

Third Modification

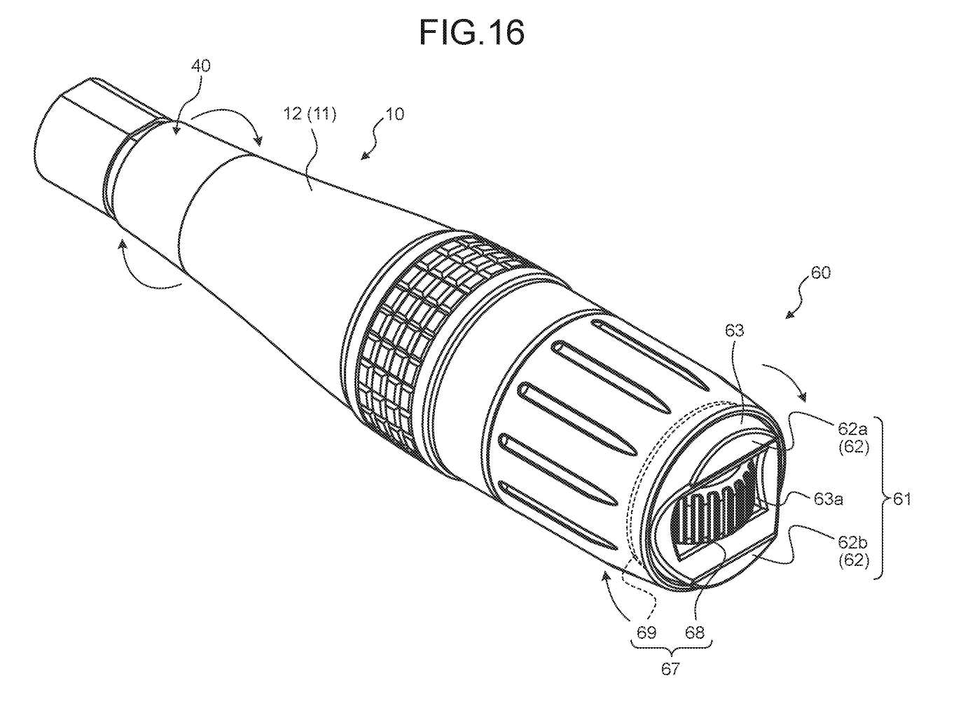

In a vehicle operation system 5 according to a third modification, the auxiliary operation device 20 in the vehicle operation system 4 according to the second embodiment described above is replaced with the auxiliary operation device 60 illustrated in FIG. 16. Similarly to the auxiliary operation device 20 according to the second embodiment, a plurality of operation forms for operating the onboard device 200 are set to the auxiliary operation device 60.

The auxiliary operation device 60 includes the first action detecting unit 61 that is the same as the auxiliary operation device 20 according to the second embodiment and the second action detecting unit 67 different from the auxiliary operation device 20 at a distal end in a projecting direction of the longitudinal member 12.

The first action detecting unit 61 according to the third modification includes a contact operation region (distal end surface) 62 similarly to the action detecting unit 21 according to the second embodiment. Here, a first contact operation region 62a and a second contact operation region 62b are provided as the contact operation region 62. The first contact operation region 62a and the second contact operation region 62b are arranged on the exposed portion of the contact operation member 63. The contact operation member 63 is a cylindrical member similar to the contact operation member 23 in FIG. 14 and FIG. 15 according to the second embodiment, and the rectangular through hole 63a is arranged at the center portion of the circular blocking surface that is the exposed portion. A longitudinal direction of the through hole 63a is preferably the direction along natural movement of the finger of the operator described in the second embodiment. The contact sensor 64 similar to the contact sensor 24 according to the second embodiment is arranged on the front surface or the back surface of the exposed portion of the contact operation member 63. As the contact sensor 64, a contact sensor 64a for the first contact operation region 62a and a contact sensor 64b for the second contact operation region 62b are prepared.

The first contact operation region 62a is arranged on the upper side of the vehicle with respect to the through hole 63a. The first contact operation region 62a is surrounded by one linear side on the through hole 63a side along natural movement of the finger of the operator, and a curved side bulging toward the upper side of the vehicle and connecting both ends of the one linear side. The curved side has a curvature in accordance with the cylindrical shape of the contact operation member 63. The contact sensor 64a is arranged on the back surface of the first contact operation region 62a. At least the touch operation is set to the first contact operation region 62a as a contact operation form. For example, the touch operation (operation of touching once) on the first contact operation region 62a can be utilized as a determination button. The slide operation along the movement of the finger of the operator may be set to the first contact operation region 62a as a contact operation form.

The second contact operation region 62b is arranged on the lower side of the vehicle with respect to the through hole 63a. The second contact operation region 62b is surrounded by one linear side on the through hole 63a side along natural movement of the finger of the operator, and a curved side bulging toward the lower side of the vehicle and connecting both ends of the one linear side. The curved side has a curvature in accordance with the cylindrical shape of the contact operation member 63. The contact sensor 64b is arranged on the back surface of the second contact operation region 62b. At least the touch operation is set to the second contact operation region 62b as a contact operation form. For example, the touch operation (operation of touching once) on the second contact operation region 62b can be utilized as a back button. The slide operation along the movement of the finger of the operator may be set to the second contact operation region 62b as a contact operation form.

The second action detecting unit 67 includes the disc-shaped dial operation member (movable body) 68 and the dial operation detecting unit 69 that detects movement of the dial operation member 68. The second action detecting unit 67 is configured similarly to what is called a tilt wheel.

The dial operation member 68 is arranged so that the axis of itself (rotation shaft) intersects with the axial direction of the distal end of the longitudinal member 12 at right angles in a state in which part of the outer peripheral surface of the dial operation member 68 is exposed from the through hole 63a, and the dial operation member 68 can rotate about the axis along the longitudinal direction of the through hole 63a. The dial operation member 68 is rotatably held with respect to the contact operation member 63, for example. In the dial operation member 68, the portion exposed from the through hole 63a is a part on which the contact operation is performed by the operator. Thus, to prevent slippage in the contact operation, a recessed part and a projecting part are alternately formed on the outer peripheral surface along a circumferential direction. The dial operation member 68 is also configured to be depressable along the axial direction of the distal end of the longitudinal member 12. The depressed dial operation member 68 can be returned to an original position due to an elastic member (not illustrated) attached to a rotation shaft or a holding part of the rotation shaft, for example.

The rotation operation about the axis of the dial operation member 68 can be used as an operation corresponding to the slide operation in the first contact operation region 22a according to the second embodiment. The depressing operation of the dial operation member 68 can be utilized as a determination operation for a selected function of the onboard device 200, for example.

The dial operation detecting unit 69 detects a rotation operation amount of the dial operation member 68 (for example, a rotation angle), and detects whether the dial operation member 68 is depressed. The dial operation detecting unit 69 transmits an output signal related to the rotation operation amount or the depression of the dial operation member 68 to the control device 30.

The control device 30 controls the onboard device 200 based on output signals from the contact sensors 64a and 64b and the dial operation detecting unit 69.

The auxiliary operation device 60 can be used as at least one of the auxiliary operation devices 20L and 20R described in the second embodiment. In the vehicle operation system 2 in this case, for example, the operator may hold down the dial operation member 68 for a certain time period or may keep a finger on the first contact operation region 62a or the second contact operation region 62b for a certain time period to perform a start operation form corresponding to the drive command or a stop operation form corresponding to the stop command described in the second embodiment. In the vehicle operation system 2, the auxiliary operation device 60 may be applied to one of the auxiliary operation devices 20L and 20R, and the auxiliary operation device 20 including the action detecting unit 21 according to the second embodiment may be applied to the other one thereof.

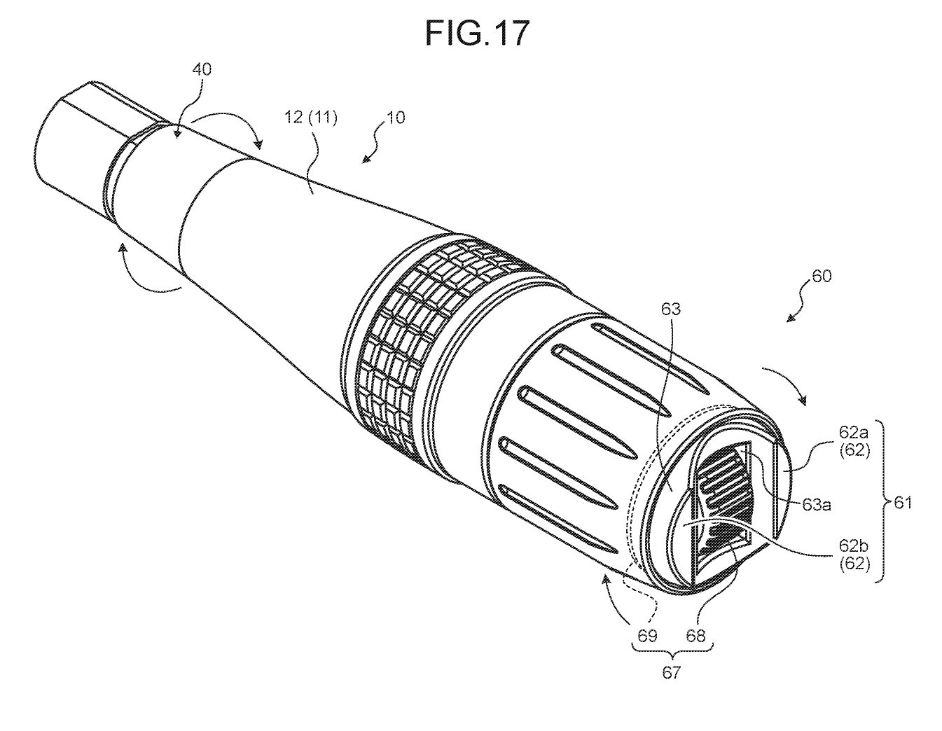

The thus configured vehicle operation system 2 includes the rotation mechanism 40 described in the second embodiment. The rotation mechanism 40 causes the first and second action detecting units 61 and 67 to rotate about the axis in the extending direction (distal end) of the longitudinal member 12. The rotation mechanism 40 causes at least the contact operation member 63 to rotate about the axis of the distal end of the longitudinal member 12. The rotation mechanism 40 mainly includes the rotation part 41 and the transmission shaft 42. With the rotation mechanism 40, the contact operation member 63 steplessly rotates about the axis. For example, when the operator intends to perform rotation operation on the dial operation member 68 by bending and stretching his/her finger in the reciprocating back and forth direction between the front side of the vehicle and the rear side of the vehicle while gripping the steering wheel 102, as illustrated in the example of FIG. 16, the operator rotates the contact operation member 63 so that the rotation direction of the dial operation member 68 is identical to the reciprocating back and forth direction connecting the front side of the vehicle and the rear side of the vehicle. When the operator intends to perform rotation operation on the dial operation member 68 by waving the finger in the vertical direction while gripping the steering wheel 102, as illustrated in the example of FIG. 17, the operator rotates the contact operation member 63 so that the rotation direction of the dial operation member 68 is identical to the vertical direction of the vehicle. In this way, the operator may cause the contact operation member 63 to rotate about the axis so that the rotation direction of the dial operation member 68 is identical to the direction in which the operator can easily move his/her finger while gripping the steering wheel 102. That is, with the vehicle operation system 2, the direction of finger action based on which the onboard device 200 is operated can be set for each operator. Even when the operator of the vehicle is replaced with another person, an operation direction desired by that person can be set in the vehicle operation system 2 similarly to the second embodiment.

Also in the third modification, the vehicle operation system 5 can improve the operability.

Fourth Modification

In the vehicle operation systems 4 and 5 according to the second embodiment and the third modification, the contact operation form is employed for the auxiliary operation devices 20 and 60 as an operation form of the operator. In contrast, for an auxiliary operation device 70 of a vehicle operation system 6 according to a fourth modification, a non-contact operation form is used as an operation form of the operator.

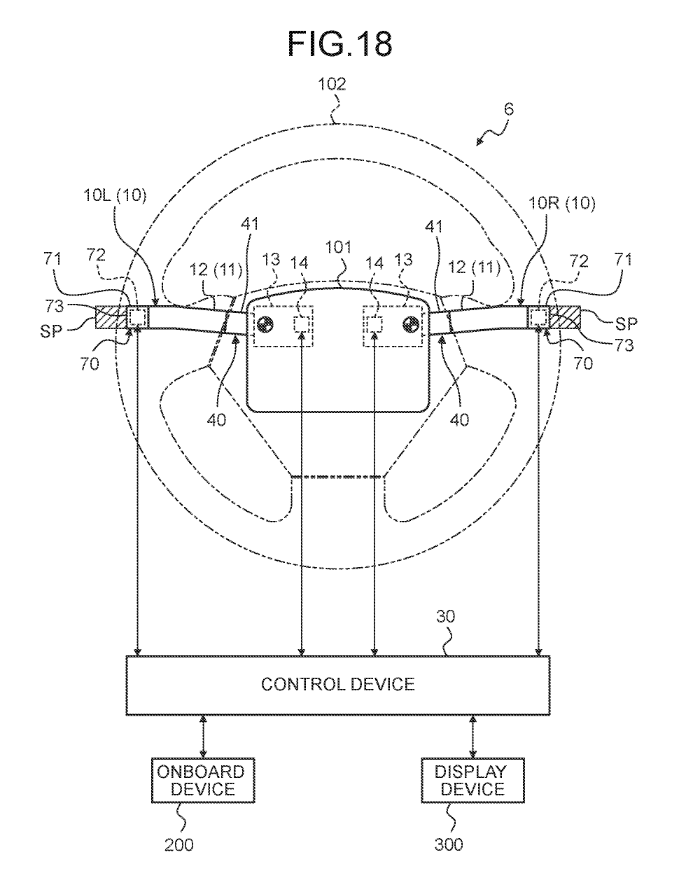

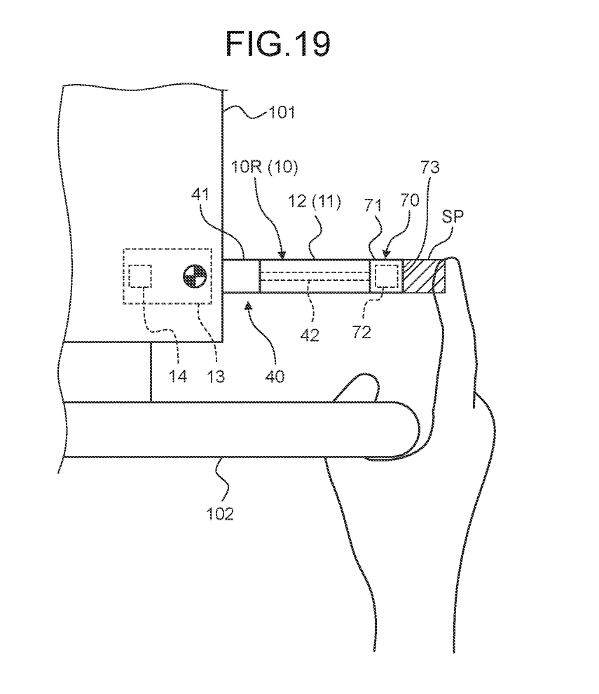

In the vehicle operation system 6 according to the fourth modification, the auxiliary operation devices 20 and 60 in the vehicle operation systems 4 and 5 according to the second embodiment are replaced with the auxiliary operation device 70 illustrated in FIG. 18 and FIG. 19. A plurality of operation forms for operating the onboard device 200 are set to the auxiliary operation device 70 similarly to the auxiliary operation devices 20 and 60 according to the second embodiment.

The auxiliary operation device 70 includes, at the distal end in the projecting direction of the longitudinal member 12, the action detecting unit 71 that detects the operation form of the operator in a non-contact state. The action detecting unit 71 can detect the operation form (non-contact operation form) of the operator in the sensing space SP with the distal end being a base point. The sensing space SP is, for example, a space at least extending from the tip of the distal end of the longitudinal member 12 toward the side part of the vehicle along the axial direction of the distal end. The action detecting unit 71 includes the non-contact sensor 72 that can detect an object present in the sensing space SP and a moving direction of the object in the sensing space SP. For example, an infrared sensor such as a near-infrared sensor can be used as the non-contact sensor 72. The sensing space SP according to the fourth modification is set, for example, to be in a range equivalent to a range in which the operator can bend and stretch his/her finger while gripping the steering wheel 102.

In the action detecting unit 71, the operation form of the operator in the sensing space SP is allocated for each function of the onboard device 200 or each of the onboard devices 200. As the operation form to be allocated, the operation form along natural movement of the finger of the operator as described in the second embodiment is preferably applied. For example, when receiving an output signal related to movement along a finger direction from the non-contact sensor 72, the control device 30 can recognize the bending and stretching action of the finger in the sensing space SP to be equivalent to the slide operation on the first contact operation region 22a according to the second embodiment. When the non-contact sensor 72 detects that a distance to the finger becomes small similarly to the touch operation according to the second embodiment, the control device 30 receives the output signal from the non-contact sensor 72 and recognizes the movement of the finger in the sensing space SP to be equivalent to the touch operation according to the second embodiment.

The auxiliary operation device 70 can be used as at least one of the auxiliary operation devices 20L and 20R described in the second embodiment. In the vehicle operation system 3, the auxiliary operation device 70 may be applied to one of the auxiliary operation devices 20L and 20R, and the auxiliary operation device 20 or 60 according to the second embodiment or the fourth modification may be applied to the other one thereof.

The rotation mechanism 40 causes a distal end surface 73 of the action detecting unit 71 to rotate about the axis of the distal end of the longitudinal member 12. The same rotation mechanism 40 as that described in the second embodiment is arranged. The rotation mechanism 40 mainly includes the rotation part 41 and the transmission shaft 42. With the rotation mechanism 40, the distal end surface 73 of the action detecting unit 71 steplessly rotates about the axis. In this way, with the vehicle operation system 6, the direction of finger action based on which the onboard device 200 is operated can be set for each operator. Even when the operator of the vehicle is replaced with another person, an operation direction desired by that person can be set in the vehicle operation system 3 similarly to the second embodiment.

As described above, also in the fourth modification, the vehicle operation system 6 can improve the operability.

In the description of the second embodiment and the third and the fourth modifications, each of the auxiliary operation devices 20, 60, and 70 is arranged at the distal end of the longitudinal member 12 that can perform inclining action in the main operation device 10. However, the action detecting units 21 and 71 of the auxiliary operation devices 20 and 70 or the first and second action detecting units 61 and 67 of the auxiliary operation device 60 may be arranged at the distal end of the immovable longitudinal member 12 the movement of which such as inclining action is prohibited. The immovable longitudinal member 12 is a long object that is projected and extended from the steering column 101, and one end thereof is fixed to the inside of the steering column 101. At least one combination of the immovable longitudinal member 12 and the action detecting unit 21 or the action detecting unit 71 or the first and second action detecting units 61 and 67 may be arranged on at least one of the left end and the right end in the vehicle width direction of the steering column 101. This combination may be arranged in place of the combination of the main operation device 10 and the auxiliary operation device 20 described above, or may be arranged in addition to the combination of the main operation device 10 and the auxiliary operation device 20.

The configuration for causing the contact operation members 23 and 63 or the distal end surface 73 of the action detecting unit 71 to rotate about the axis of the distal end of the longitudinal member 12 is not limited to the rotation mechanism 40 including the rotation part 41 and the transmission shaft 42. For example, the contact operation members 23 and 63 or the distal end surface 73 of the action detecting unit 71 may be configured to rotate about the axis at the distal end of the longitudinal member 12 without using the transmission shaft 42. For example, the rotation mechanism may be configured with an annular projecting part formed in a projecting shape on a radial outside along a circumferential direction of an outer peripheral surface of the contact operation member 23, and a guide groove (guide groove in the circumferential direction) formed on an inner peripheral surface of the opening at the distal end of the main body portion of the longitudinal member 12 to accommodate the annular projecting part. The annular projecting part is formed to be freely rotatable along the circumferential direction in a state of being fitted in the guide groove. With such a configuration, the contact operation member 23 can be rotated about the axis at the distal end of the longitudinal member 12. For example, the contact operation members 23 and 63 and the distal end surface 73 of the action detecting unit 71 may be configured to be detachable from the distal end of the longitudinal member 12. In this case, the operator detaches the contact operation members 23 and 63 or the distal end surface 73 of the action detecting unit 71 from the distal end of the longitudinal member 12. Then the operator may attach the contact operation members 23 and 63 or the distal end surface 73 of the action detecting unit 71 to the distal end of the longitudinal member 12 while changing an angle with respect to the axis at the distal end of the longitudinal member 12 so that the direction of finger action in the first contact operation regions 22a and 62a or the distal end surface 73 of the action detecting unit 71 extends along the direction in which the operator can easily move his/her finger while gripping the steering wheel 102. With such a configuration, angles of the contact operation members 23 and 63 or the distal end surfaces 22, 62, and 73 of the action detecting unit 71 can be changed with respect to the axis at the distal end of the longitudinal member 12 without the rotation mechanism 40.

The rotation mechanism 40 may include a lock mechanism for preventing the contact operation members 23 and 63 or the distal end surfaces 22, 62, and 73 of the action detecting unit 71 from being unintentionally rotated about the axis. In a state in which the lock mechanism is released, the rotation mechanism 40 can cause the contact operation members 23 and 63 or the distal end surfaces 22, 62, and 73 of the action detecting unit 71 to rotate about the axis. In a state in which the lock mechanism is locked, the contact operation members 23 and 63 or the distal end surfaces 22, 62, and 73 of the action detecting unit 71 are restrained from being rotated about the axis.

The main operation device 10 may include an additional auxiliary operation device (not illustrated) that is different from the auxiliary operation devices 20, 60, and 70. The additional auxiliary operation device includes, for example, a concentric annular member arranged for covering the outer peripheral surface of the longitudinal member 12, and causes the annular member to rotate about the axis to select a function of the onboard device 200.

In the second embodiment, the action detecting unit preferably includes a rotation mechanism that causes the action detecting unit to rotate about the axis in the extending direction of the longitudinal member.

The rotation mechanism preferably includes a rotation part that is arranged while covering the circumferential direction of the longitudinal member and rotates about the axis of the longitudinal member to cause the action detecting unit to rotate.

The rotation mechanism preferably includes a transmission shaft that is arranged between the rotation part and the action detecting unit, and transmits the rotation at the rotation part to the action detecting unit.

The action detecting unit preferably includes a contact sensor that can detect an object being in contact with the distal end surface and a moving direction of the object, and the contact sensor preferably detects a contact operation as the operation form.

The action detecting unit preferably includes a non-contact sensor that can detect an object positioned in the sensing space and a moving direction of the object, and the non-contact sensor preferably detects a non-contact operation as the operation form.

The action detecting unit is preferably arranged on the distal end surface side, includes a movable body that can be moved by the contact operation, and detects action of the movable body as the operation form.

At least one combination of the longitudinal member and the action detecting unit is preferably arranged on at least one of the left end and the right end in the vehicle width direction of the steering column.

Preferably provided are: a main operation device including a lever operation unit that includes the longitudinal member and a lever operation detecting unit that detects an inclining direction of inclining action using an end of the longitudinal member on the steering column side as a fulcrum, and operating the onboard device allocated to the inclining direction of the inclining action as an operation direction of the longitudinal member or an onboard device different from the former onboard device; and an auxiliary operation device including the action detecting unit.

At least one combination of the main operation device and the auxiliary operation device is preferably arranged on at least one of the left end and the right end in a vehicle width direction of the steering column.

In the vehicle operation system according to the present invention, the direction along natural movement of the finger of the operator gripping the steering wheel is selected as the operation direction in the action detecting unit. Thus, with the vehicle operation system, the operator can perform operation set in advance by moving his/her finger without a sense of incongruity. Accordingly, the vehicle operation system can reduce a burden on the finger of the operator in operation.

Also, the vehicle operation system according to the present invention exhibits an effect of improving the operability.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle operation system comprising:
a longitudinal member that is projected and extended from a steering column;
an action detecting unit that is arranged at a distal end in a projecting direction of the longitudinal member, and detects an operation form of an operator in operating an onboard device at the distal end or in a sensing space with the distal end being a base point; and
a controller that transmits a command to the onboard device based on an output signal from the action detecting unit in accordance with the operation form of the operator, wherein
the action detecting unit sets an operation direction along natural movement of a finger of the operator gripping a steering wheel, and allocates a function of the onboard device to the operation direction.

2. The vehicle operation system according to claim 1, wherein
the operation direction along natural movement of the finger of the operator is a direction along a bending and stretching direction of the finger or a direction orthogonal to the direction along the bending and stretching direction.

3. The vehicle operation system according to claim 1, wherein
the action detecting unit includes a contact sensor capable of detecting an object being in contact with a contact operation region of the distal end and a moving direction of the object, or a non-contact sensor capable of detecting an object present in the sensing space and a moving direction of the object in the sensing space.

4. The vehicle operation system according to claim 2, wherein
the action detecting unit includes a contact sensor capable of detecting an object being in contact with a contact operation region of the distal end and a moving direction of the object, or a non-contact sensor capable of detecting an object present in the sensing space and a moving direction of the object in the sensing space.

5. The vehicle operation system according to claim 1, wherein
at least one combination of the longitudinal member and the action detecting unit is arranged on at least one of a left end and a right end of the steering column in a vehicle width direction.

6. The vehicle operation system according to claim 2, wherein
at least one combination of the longitudinal member and the action detecting unit is arranged on at least one of a left end and a right end of the steering column in a vehicle width direction.

7. The vehicle operation system according to claim 3, wherein
at least one combination of the longitudinal member and the action detecting unit is arranged on at least one of a left end and a right end of the steering column in a vehicle width direction.

8. The vehicle operation system according to claim 1, further comprising:
a main operation device including a lever operation unit that includes the longitudinal member and a lever operation detecting unit that detects an inclining direction of inclining action using an end of the longitudinal member on the steering column side as a fulcrum, and operating the onboard device allocated to the inclining direction of the inclining action as an operation direction of the longitudinal member or an onboard device different from the former onboard device, and
an auxiliary operation device including the action detecting unit.

9. The vehicle operation system according to claim 2, further comprising:
a main operation device including a lever operation unit that includes the longitudinal member and a lever operation detecting unit that detects an inclining direction of inclining action using an end of the longitudinal member on the steering column side as a fulcrum, and operating the onboard device allocated to the inclining direction of the inclining action as an operation direction of the longitudinal member or an onboard device different from the former onboard device, and
an auxiliary operation device including the action detecting unit.

10. The vehicle operation system according to claim 3, further comprising:
a main operation device including a lever operation unit that includes the longitudinal member and a lever operation detecting unit that detects an inclining direction of inclining action using an end of the longitudinal member on the steering column side as a fulcrum, and operating the onboard device allocated to the inclining direction of the inclining action as an operation direction of the longitudinal member or an onboard device different from the former onboard device, and
an auxiliary operation device including the action detecting unit.

11. The vehicle operation system according to claim 5, further comprising:
a main operation device including a lever operation unit that includes the longitudinal member and a lever operation detecting unit that detects an inclining direction of inclining action using an end of the longitudinal member on the steering column side as a fulcrum, and operating the onboard device allocated to the inclining direction of the inclining action as an operation direction of the longitudinal member or an onboard device different from the former onboard device, and
an auxiliary operation device including the action detecting unit.

12. The vehicle operation system according to claim 8, wherein
at least one combination of the main operation device and the auxiliary operation device is arranged on at least one of the left end and the right end of the steering column in the vehicle width direction.

13. The vehicle operation system according to claim 1, wherein
the action detecting unit has a distal end surface at a distal end in an extending direction of the longitudinal member, detects an operation form allocated to a working form included in the onboard device on the distal end surface side or in a sensing space with the distal end surface being a base point, and is arranged so that an angle of at least the distal end surface is capable of being freely changed about an axis at the distal end of the longitudinal member, and
the controller controls the onboard device based on the operation form detected by the action detecting unit.
